(19) United States
(12) Patent Application Publication
(10) Pub. No.: US 2008/0270658 A1
(43) Pub. Date: Oct. 30, 2008

(54) PROCESSOR SYSTEM, BUS CONTROLLING METHOD, AND SEMICONDUCTOR DEVICE

(75) Inventors: Keisuke KANEKO, Kyoto (JP); Takao YAMAMOTO, Osaka (JP); Masayuki YAMASAKI, Osaka (JP); Nobuo HIGAKI, Hyogo (JP); Kazushi KURATA, Osaka (JP); Ryuta NAKANISHI, Kyoto (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/108,754

(22) Filed: Apr. 24, 2008

(30) Foreign Application Priority Data
Apr. 27, 2007 (JP) 2007-118709
Apr. 23, 2008 (JP) 2008-113094

(51) Int. Cl. G06F 13/372

(52) U.S. Cl. 710/117

(57) ABSTRACT

Provided is a simply structured multiprocessor system which equally distributes access performance for accessing a shared memory among plural master units accessing the shared memory. The multiprocessor system includes plural master units PU0 and PU1 each of which issues an access request for accessing the shared memory, a bus IF unit 4-10 which accesses a bus by a split transaction scheme and separately executes a request phase for accepting the access request; and a transfer phase for executing data transfer in response to the accepted access request. In the case where one of the master units consecutively issues plural access requests without an interval of a predetermined time period, the bus IF unit 4-10 restricts the number of consecutive transfer phase executions corresponding to the plural access requests to be not more than N.

### BACKGROUND OF THE INVENTION

(1) Field of the Invention

The present invention relates to a processor system of a multiprocessor having a plurality of processors, and to a bus controlling method in such a processor system.

(2) Description of the Related Art

When a multiprocessor having a plurality of processors accesses a shared memory via a shared memory bus, one of the processors frequently makes bus access, and in the case where the processor is a high-priority processor, access requests from other processors are less likely to be accepted.

To solve a problem similar to the above which arises when a plurality of bus masters access a single shared bus, the prior art offers a method of monitoring access frequency of each bus master and dynamically changing the priority at the time of arbitration (See, Patent Reference 1: Japanese Unexamined Patent Application Publication 2002-91903, FIGS. 1 and 6).

According to this technique, the access status of each bus master during a fixed period of time is monitored, and the priority of a bus master which has made frequent access in the fixed period of time is lowered in the next period. This solves the problem of a particular bus master continuously using the bus and not allowing other bus masters to make bus access, even in the case where the bus master has made frequent bus access.

However, this method is applicable at the time of arbitration in the case of conflicts between bus masters with requests, and thus its advantage is only such that a low-priority bus master can access the bus at a certain rate in the case where a high-priority bus master continuously makes request or where access requests are made at the same time.

In the systems employing a bus of a split transaction scheme where requests and data transmission can be operated at separate phases as it is today, the prior art technique cannot function appropriately. This is because in such systems, the cycle intervals at which access requests can be accepted are long, and when access requests are consecutively issued, it is more likely that the requests are accepted prior to the conflicting status.

FIG. 1 is a diagram illustrating a structure of a system having a multiprocessor. This processor system includes a multiprocessor 1-1, a Direct Memory Access (DMA) 1-2, a Digital Signal Processor (DSP) 1-3, a shared bus IF unit 1-17, and a shared memory 1-23.

The multiprocessor 1-1 is a symmetrical multiprocessor having two processor units (PU) which have pipe lines for executing instructions and the related control, and includes a PU0 (1-4), a PU1 (1-5), and a bus IF unit 1-12.

A PU0 access request 1-6 from the PU0 (1-4) and a PU1 access request 1-7 from the PU1 (1-5) are arbitrated by the bus IF unit 1-12, and one of the access requests is accepted. In the case where the PU0 access request 1-6 is accepted, a PU0 access acceptance 1-8 is sent to the PU0 1-4, and in the case where the PU1 access request 1-7 is accepted, a PU1 access acceptance 1-9 is sent to the PU1 1-5.

Having accepted a request from one of the processor units, the bus IF unit 1-12 sends a processor bus request 1-14 to the shared bus IF unit 1-17. The bus IF unit 1-12 is capable of accepting another request even while making a data transfer.

The shared bus IF unit 1-17 is also connected with a DMA bus 1-18 and a DSP bus 1-19. The shared bus IF unit 1-17 arbitrates between the access requests and sends a shared memory bus request 1-20 to the shared memory 1-23. Having accepted the request, the shared memory 1-23 sends a shared memory bus request acceptance 1-21. When the access is completed, the shared memory 1-23 sends a shared memory bus acknowledgment 1-22 to the shared bus IF unit 1-17. Here, from the viewpoint of the shared memory bus 1-24, the bus IF unit 1-12 functions as a single master. More specifically, in FIG. 1, the multiprocessor 1-1 (the bus IF unit 1-12), the DMA 1-2 and the DSP 1-3 function as three masters from the viewpoint of the shared memory bus 1-24.

FIG. 2 illustrates a bus protocol of a bus provided in the system. It is assumed that all buses mentioned hereinafter are in accordance with this protocol.

The protocol of each bus is such that after making a request 2-1, a new request can be issued even before data 2-4 arrives with an acknowledgment 2-3. This allows the bus to enable efficient data transfer when consecutive data transfers are executed (split transaction bus). It is effective especially when the shared memory is such a device as a synchronous Dynamic Random Access Memory (DRAM) or a Double-Data-Rate Synchronous DRAM (DDR SDRAM) with a long latency for the first data transfer but with a high throughput for consecutive data transfers.

The request 2-1 issued by one of the bus masters continues to be asserted until the access destination accepts the request. When the access destination sends a request acceptance 2-2, the request 2-1 is negated. As apparent from FIG. 2, the next request B is accepted even before the data transfer related to the request A is completed.

FIG. 3 is a diagram illustrating bus timings in the case where the PU0 (1-4) and the PU1 (1-5) in the multiprocessor 1-1 make access to a slave device via a processor bus 1-13.

In FIG. 3, it is assumed that a request A (3-1) and a request B (3-2) are asserted by the PU0 (1-4), and after that, a request C (3-3) is asserted by the PU1 (1-5). As mentioned above, each processor unit is capable of making the next request before the transfer corresponding to the previous request is completed, and the bus IF unit 1-12 is capable of accepting the next request before the transfer corresponding to the previous request is completed. The following description is based on an example case where a request refers to a read request, and it is burst access where a cache line in the case of a cache miss is refilled. Here, it is assumed that a plurality of word data items are transferred through a burst transfer with a single request (four burst transfers in FIG. 3). Note that in FIG. 3, a timing chart corresponding to the shared memory bus is omitted.

The bus IF unit 1-12 sequentially accepts and executes the access requests asserted by the processor units. Therefore, as illustrated in FIG. 3, when a processor bus request 1-14 is made such that a bus request A, a bus request B, and a bus request C are requested in this order, data items respectively corresponding to the request A (3-1), the request B (3-2), and the bus request C (3-3) are transferred also in this order.

The latency of the request A (3-1) is a cycle cycA (3-7). The cycle cycA (3-7) can be considered as the number of bus access cycles of each processor unit within the processor (1-1) in the case where bus access is not causing a conflict for accessing the shared memory (1-23).

The data corresponding to the request B (3-2) is transferred after the data transfer corresponding to the request A (3-1) is completed, and the data corresponding to the request C (3-3) is transferred after the data transfers corresponding to the request A (3-1) and the request B (3-2) are completed. Consequently, this results in the latency of the request C (3-3), a cycle cycc (3-8), to be longer than the cycle cycA (3-7).

More specifically, although the processor (1-1) is a symmetric multiprocessor, the PU0 (1-4) making frequent bus access has an adverse impact on the bus access performance of the PU1 (1-5).

No problem arises if the above mentioned adverse impact on the bus access performance is equal among the processor units. However, in the case where one of the processor units makes frequent bus access and where this processor unit is likely to issue a request prior to the other processor unit in terms of timing, a problem may arise that the bus access conflict has more adverse impact on the other processor unit. In such a case, despite the fact that the multiprocessor is a symmetric multiprocessor, the bus access performance of one of the processor units is practically inferior to that of the other processor unit.

In the case of the symmetric multiprocessor, plural Central Processing Unit (CPU) cores respectively provided with plural processor units are all the same. Thus, when estimating processing performance of software, the following is generally undertaken: Operations of an individual CPU core are considered; estimate the operation performance based on the result of the consideration, taking into account the degradation caused by conflict; and estimate with an assumption that the software is executed with the same operation performance in both of the CPU cores in which the software is installed. In this case, the adverse impact of sharing the bus is taken into account for the bus access performance, however, an error in the estimation of the performance becomes larger if this adverse impact is not equally allocated to both of the CPU cores. Furthermore, there is also an adverse impact on the system performance when the performance of only one of the CPU cores degrades.

In other words, in the multiprocessor system, it is not possible to accurately estimate the bus access performance.

Furthermore, even with a multithread processor, a problem similar to the above described multiprocessor problem arises, and there are cases where it is desired to prevent the bus access performance from stemming only from a particular thread. More specifically, even with a multithread processor, there are cases where it is desired to equally allocate the bus band width to each thread and to equally allocate, to each thread, the adverse impact of the bus access caused by the conflict

### SUMMARY OF THE INVENTION

An object of the present invention is to provide a simply structured multiprocessor system, bus controlling method and semiconductor device that equalize the access performance for accessing a shared memory among plural master units that access the shared memory.

Furthermore, another object of the present invention is to provide a simply structured multiprocessor system, bus controlling method and semiconductor device which are capable of controlling the distribution of the access performance among the plural master units.

In order to solve the above described problems, the processor system according to the present invention is a processor system comprising: a bus connected to a shared memory; master units each of which issues an access request for accessing the shared memory; and a bus interface unit which accesses the bus by a split transaction scheme and executes a request phase and a transfer phase separately, the request phase being a phase for accepting the access request issued by each of the master units, and the transfer phase being a phase for executing data transfer between the shared memory and each of the master units via the bus in response to the accepted access request, wherein in the case where one of the master units consecutively issues plural access requests without an interval of a predetermined time period between each of the access requests, the bus interface unit restricts the number of consecutive executions of transfer phases to be not more than N, the transfer phases respectively corresponding to the plural access requests, and the predetermined time period is equivalent to a part of or an entire time period from when an immediately previously issued access request is accepted, to when the transfer phase corresponding to the immediately previously issued access request is completed. With this, the structure is simple, and the access performance can be equally distributed among master units, since, in the case where plural access requests are consecutively issued under the limited condition that no interval of the above mentioned predetermined time period is provided, the number of consecutive transfer phase executions which correspond to the plural access requests is restricted.

Here, it may be that N is 1. With this structure, the access performance can be equalized, since making the number of consecutive executions of the transfer phase N to be the minimum of 1 makes it possible, in the case of a conflict among access requests of plural master units, to alternately execute the transfer phases corresponding to the different master units, or to execute them while switching between the transfer phases corresponding to the different master units.

Here, it may be that the bus interface unit includes: an acceptance controlling unit which controls the acceptance of the access request; a transfer controlling unit which controls the data transfer; an identification information holding unit which holds identification information of at least one of the master units, the identification information of the at least one of the master units corresponding to the access request which has been accepted and for which the transfer phase has not been completed; and a flag holding unit which holds flag information which is valid during the predetermined time period, and that when a new access request is issued, the acceptance controlling unit performs the following: accept the new access request in the case where the flag information is invalid; judge whether or not identification information of one of the master units which has issued the new access request and the identification information held by the identification information holding unit match each other, in the case where the flag information is valid; accept the new access request in the case where it is judged that the identification information of the one of the master units which has issued the new request and the identification information held by the identification information holding unit do not match each other; and restrict the number of consecutive executions of the transfer phases to be not more than N, in the case where it is judged that the identification information of the one of the master units which has issued the new request and the identification information held by the identification information holding unit match each other, the transfer phases corresponding to the one of the master units which has issued the new access request. With this structure, restricting the acceptance in the request phase makes it possible to restrict the number of consecutive executions of the transfer phase of a single master unit. Further, the access performance can be equalized based on the simple structure of holding the identification information and the flag information.

Here, it may be that the predetermined time period is a time period from when the access request is accepted, to when the transfer phase corresponding to the access request is completed, that every time the access request is accepted, the acceptance controlling unit validates the flag information held by the flag holding unit and sets the identification information corresponding to the access request in the identification information holding unit, and that the transfer controlling unit invalidates the flag information held by the flag holding unit when the transfer phase corresponding to the identification information held by the identification information holding unit is completed. With this structure, in the case where one of the master units consecutively issues plural access requests without the interval of the above mentioned predetermined time period, the number of consecutive transfer phase executions corresponding to the plural access requests can be restricted. The flag information is validated (set) when an access request is accepted, and invalidated (reset) when a transfer phase of the access request is completed. As described, the flag information can be simply controlled.

Here, it may be that the predetermined time period is a time period from when the access request is accepted, to when a predetermined number of cycles elapse, and that the processor system further comprises a cycle counter which counts the predetermined number of cycles, wherein every time the access request is accepted, the acceptance controlling unit validates the flag information held by the flag holding unit, sets the identification information corresponding to the access request in the identification information holding unit, and causes the cycle counter to start counting the predetermined number of cycles, and the flag holding unit invalidates the flag information when the cycle counter has counted the predetermined number of cycles. With this structure, the predetermined time period may be set to be: (i) a time period equivalent to the time period from when the access request is accepted, to when the transfer phase corresponding to the access request is completed; a time period shorter than (i); or a time period longer than (i). For example, the predetermined time period may be arbitrated and set to an optimal value based on a measured value of the actual bus access performance of each master unit.

Here, it may be that the processor system of the present invention further comprises a cycle register which holds the predetermined number of cycles, the predetermined number of cycles being settable, wherein the cycle counter counts the predetermined number of cycles held by the cycle register. With this structure, the cycle register is settable, and thus the number of cycles can be arbitrated and set according to the processing amount and the access frequency.

Here, it may be that the bus interface unit includes: an acceptance controlling unit which controls the acceptance of the access request; a transfer controlling unit which controls the data transfer; an identification information holding unit which holds identification information of at least one of the master units, the identification information of the at least one of the master units corresponding to the access request which has been accepted and for which the transfer phase has not been completed; a flag holding unit which holds flag information which is valid during the predetermined time period; and a consecutive number counter which counts N, and that when a new access request is issued, the acceptance controlling unit performs the following: accept the new access request in the case where the flag information is invalid; judge whether or not identification information of one of the master units which has issued the new access request and the identification information held by the identification information holding unit match each other, in the case where the flag information is valid; accept the new access request in the case where it is judged that the identification information of the one of the master units which has issued the new request and the identification information held by the identification information holding unit do not match each other; judge whether or not the consecutive number counter has counted N, in the case where it is judged that the identification information of the one of the master units which has issued the new request and the identification information held by the identification information holding unit match each other; accept the new access request in the case where it is judged that the consecutive number counter has not counted N; and delay the acceptance of the new access request until the flag information becomes invalid and initialize the consecutive number counter, in the case where it is judged that the consecutive number counter has counted N. With this structure, the restriction on the number of consecutive executions of the transfer phase to be not more than N can be easily controlled by the consecutive number counter.

Here, it may be that the processor system of the present invention further comprises: a consecutive number register which can be set by one of the master units and holds N, wherein the consecutive number counter counts N held by the consecutive number register. With this structure, the consecutive number register can be set by one of the master units, and thus one of the master units can arbitrate and set the consecutive number N according to the processing amount and the access frequency.

Here, it may be that the bus interface unit includes: an acceptance controlling unit which controls the acceptance of the access request; a transfer controlling unit which controls the data transfer; a first identification information holding unit which holds, as first identification information, identification information of at least one of the master units, the identification information of the at least one of the master units corresponding to the access request which has been accepted and for which the transfer phase has not been completed; a flag holding unit which holds flag information which is valid during the predetermined time period; and a second identification information holding unit which holds, as second identification information, identification information of one of the master units, which is to be restricted from accessing the shared memory, and that when a new access request is issued, the acceptance controlling unit performs the following: accept the new access request in the case where the flag information is invalid; judge whether or not identification information of one of the master units which has issued the new access request matches the first identification information and the second identification information, in the case where the flag information is valid; accept the new access request in the case where it is judged that the identification information of the one of the master units which has issued the new request does not match at least one of the first identification information and the second identification information; and delay the acceptance of the new access request until the flag information becomes invalid, in the case where it is judged that the identification information of the one of the master units which has issued the new request matches both the first identification information and the second identification information. With this structure, it is possible to restrict the number of consecutive executions of the transfer phase of only the master unit, among the master units, which corresponds to the identification information held by the second identification information holding unit. With this, it is possible to control the distribution of the access performance among the master units.

Here, it may be that the processor system of the present invention further comprises: a counting unit which counts how many times each of the master units has accessed the shared memory in every fixed time period; and a setting unit which sets, in the second identification information holding unit, identification information of one of the master units which has accessed the shared memory a greatest number of times, as the second identification information. With this structure, every time a fixed time period elapses, it is possible to change the master unit whose number of consecutive executions of the transfer phase is to be restricted. With this, the master unit with the greatest number of previous accesses becomes the subject to restriction in the next fixed time period, and as a result, it is possible to equalize the access performance among the master units in a long time period including several fixed time periods.

Here, it may be that the bus interface unit includes: an acceptance controlling unit which controls the acceptance of the access request; a transfer controlling unit which controls the data transfer; an identification information holding unit which holds identification information of at least one of the master units, the identification information of the at least one of the master units corresponding to the access request which has been accepted and for which the transfer phase has not been completed; and a flag holding unit which holds flag information which is valid during the predetermined time period; and that the transfer controlling unit performs the following: execute the transfer phase corresponding to the access request which has been accepted and for which the transfer phase has not started, in the case where the flag information is invalid; judge whether or not identification information of one of the master units that has issued the access request which has been accepted and for which the transfer phase has not started, and the identification information held by the identification information holding unit match each other, in the case where the flag information is valid; start the transfer phase corresponding to the access request which has been accepted and for which the transfer phase has not started, in the case where it is judged that the identification information of the one of the master units that has issued the access request which has been accepted and for which the transfer phase has not started, and the identification information held by the identification information holding unit do not match each other; and delay the start of the transfer phase until the flag information becomes invalid, in the case where it is judged that the identification information of the one of the master units that has issued the access request which has been accepted and for which the transfer phase has not started, and the identification information held by the identification information holding unit match each other. With this structure, it is possible to restrict the number of consecutive executions of the transfer phase of a single master unit by controlling the start timing of the transfer phase instead of the request phase. Further, it is possible to make the timing at which an access request is accepted earlier. Furthermore, the access performance can be equalized based on the simple structure of holding the identification information and the flag information.

Here, it may be that the master units are processor units included in a symmetric multiprocessor.

Here, it may be that the master units are virtual processors provided in processor units included in a multiprocessor.

Here, it may be that the master units are virtual processors corresponding to threads included in a multithread processor. With this structure, the access performance can be equally distributed even among virtual processors, each of which includes at least one thread.

Here, it may be that the master units and the bus interface unit are included in a single semiconductor chip.

Here, it may be that the multithread processor issues identification information and an access attribute of a thread, in addition to the access request, that the access attribute indicates whether or not restriction on the consecutive executions of the transfer phases should be valid, and that the bus interface unit restricts the number of consecutive executions of the transfer phases to be not more than N, in the case where the access attribute corresponding to the access request indicates valid. With this structure, it is possible to control whether or not to restrict, for every thread, the number of consecutive executions of the transfer phase.

Here, it may be that the multithread processor issues identification information and an access attribute of a thread, in addition to the access request, that the access attribute is a group number indicating a group including at least one thread, and that the bus interface unit restricts, for every group number, the number of consecutive executions of the transfer phases to be not more than N, the transfer phases corresponding to the access requests of one group. With this structure, it is possible to control, for every thread indicated by the same group number, the restriction on the number of consecutive executions of the transfer phase.

Further, the bus controlling method and the semiconductor device of the present invention have means and advantages similar to that described above.

According to the present invention, when each master unit in a multiprocessor system having plural processors accesses a shared memory, it is possible, with a simple method, to equally distribute the impact of the bus arbitration and the bus access performance for accessing the shared memory bus among the plural master units. In addition, according to the present invention, it is possible to control how the access performance is distributed.

According to the present invention, it is possible to distribute, among plural threads or among threads with different attributes, the impact of the bus arbitration and the bus access performance for accessing the shared memory bus.

With this, it is possible to reduce the inequality of the bus access performance for accessing the shared memory bus among processors. As a result, it is possible to significantly improve the accuracy of estimating the processing performance of each master unit.

### FURTHER INFORMATION ABOUT TECHNICAL BACKGROUND TO THIS APPLICATION

The disclosures of Japanese Patent Application No. 2007-118709 filed on Apr. 27, 2007 and Japanese Patent Application No. 2008-113094 filed on Apr. 23, 2008 including specification, drawings and claims are incorporated herein by reference in their entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a diagram illustrating a structure of a conventional multiprocessor system;

FIG. 2 is a diagram illustrating a bus interface protocol;

FIG. 3 is a diagram illustrating conventional access timings;

FIG. 4A is a diagram of a system structure according to a first embodiment;

FIG. 4B is a flow chart illustrating acceptance control processing performed by an acceptance controlling unit;

FIG. 4C is a flow chart illustrating transfer control processing performed by a transfer controlling unit;

FIG. 4D is a diagram of a system structure according to a variation of the first embodiment;

FIG. 4E is a flow chart illustrating acceptance control processing according to the variation shown in FIG. 4D;

FIG. 4F is a flow chart illustrating transfer control processing according to the variation shown in FIG. 4D;

FIG. 5 is a diagram illustrating access timings according to the first embodiment;

FIG. 6A is a diagram illustrating access timings according to the first embodiment;

FIG. 6B is a diagram illustrating access timings according to the variation of the first embodiment;

FIG. 7A is a diagram of a system structure according to a second embodiment;

FIG. 7B is a flow chart illustrating acceptance control processing performed by an acceptance controlling unit;

FIG. 7C is a flow chart illustrating transfer control processing performed by a transfer controlling unit;

FIG. 8A is a diagram of a system structure according to a third embodiment;

FIG. 8B is a flow chart illustrating acceptance control processing performed by an acceptance controlling unit;

FIG. 9A is a diagram of a system structure according to a fourth embodiment;

FIG. 9B is a flow chart illustrating acceptance control processing performed by an acceptance controlling unit; and

FIG. 10 is a diagram of a system structure according to a fifth embodiment.

### DESCRIPTION OF THE PREFERRED EMBODIMENT(S)

### First Embodiment

A first embodiment of the present invention shall be described below. The processor system according to the present embodiment is structured in such a manner that in the case where one of the master units consecutively issues plural access requests without an interval of a predetermined time period, the number of consecutive executions of transfer phase corresponding to the plural access requests is restricted to be not more than N. Here, the predetermined time period is equivalent to a part of or an entire time period from when an immediately previously issued access request is accepted, to when the transfer phase corresponding to the immediately previously issued access request is completed. With this, it is possible to equally distribute the access performance among master units.

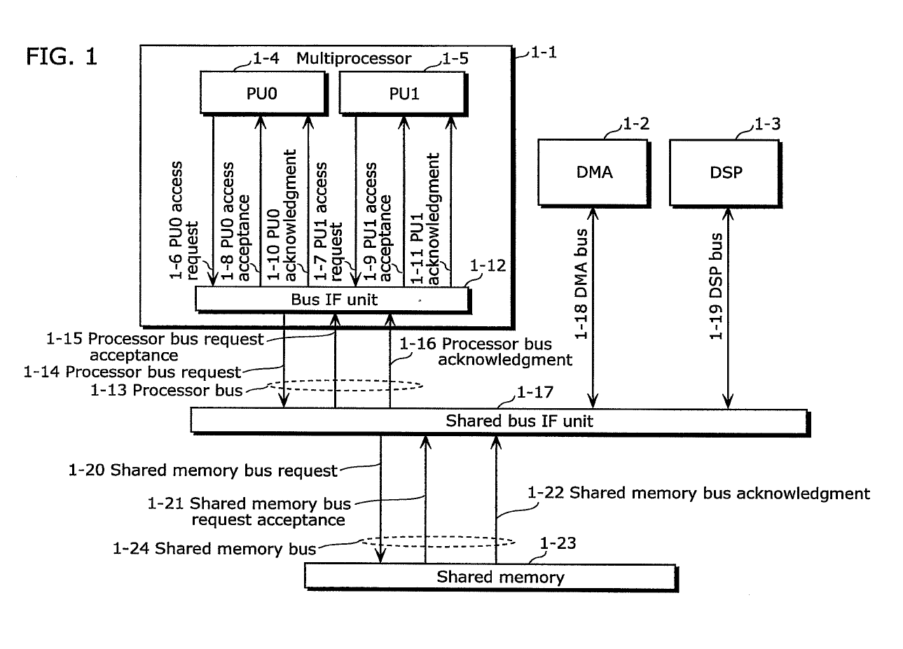

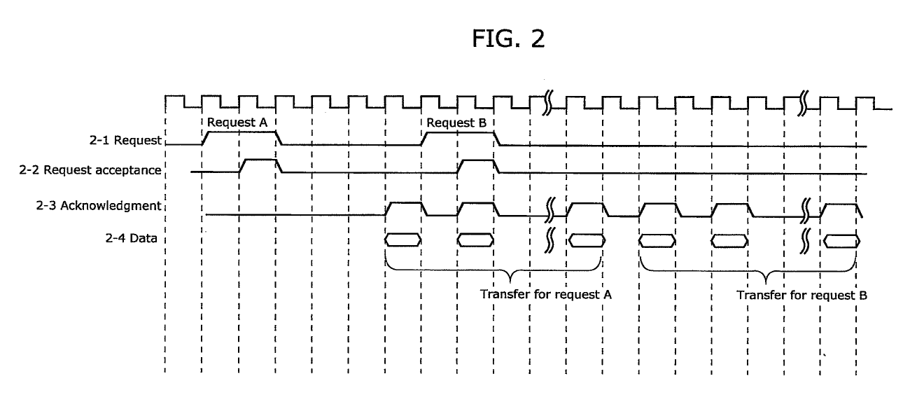

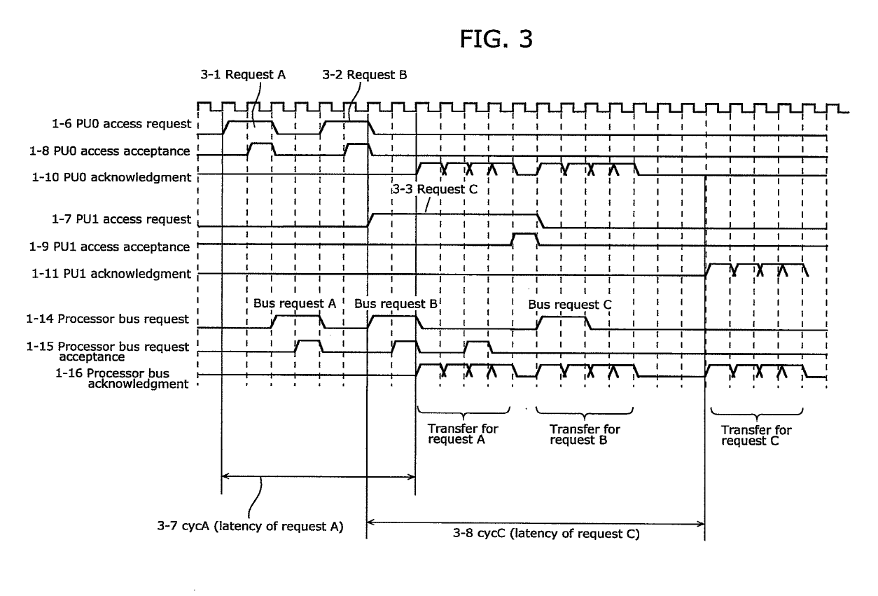

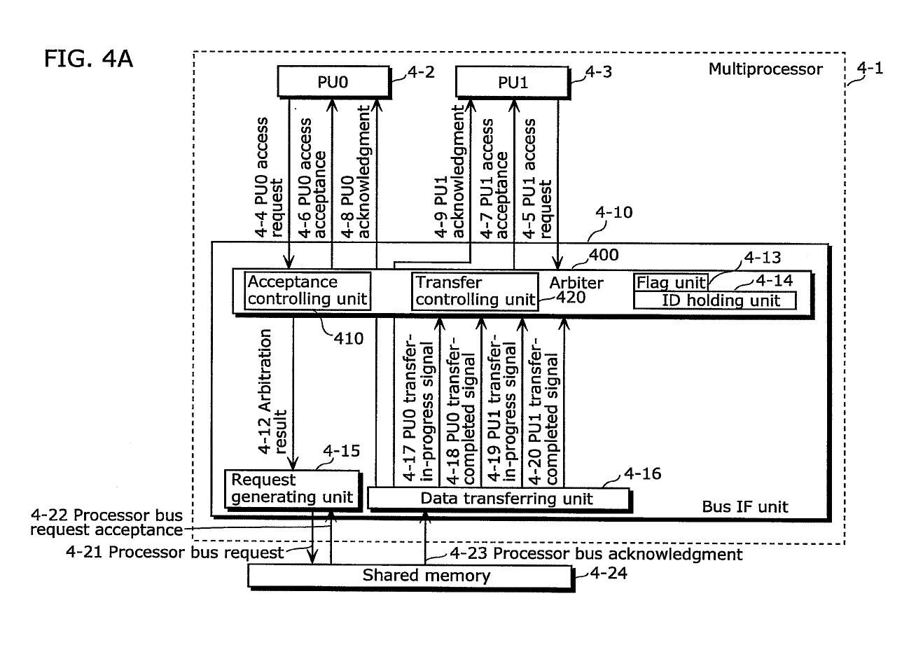

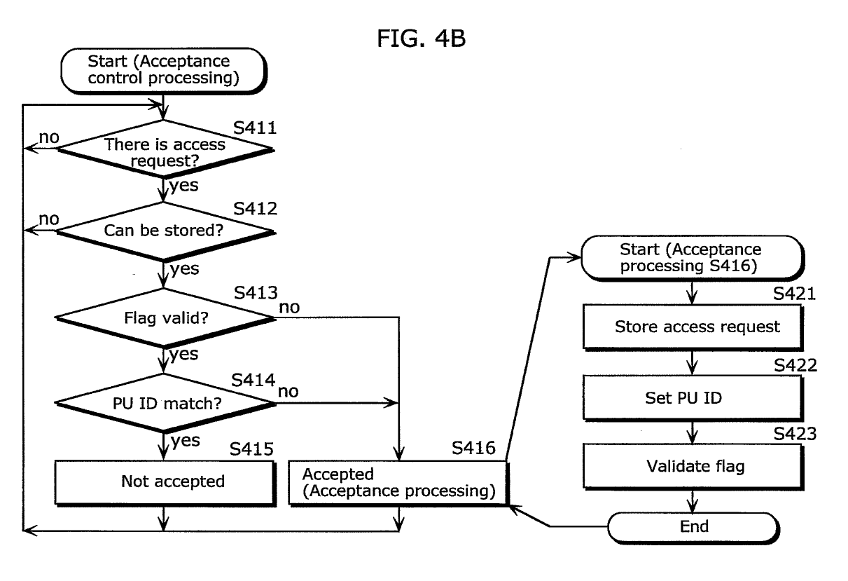

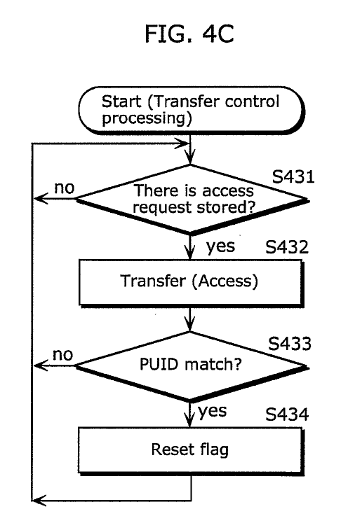

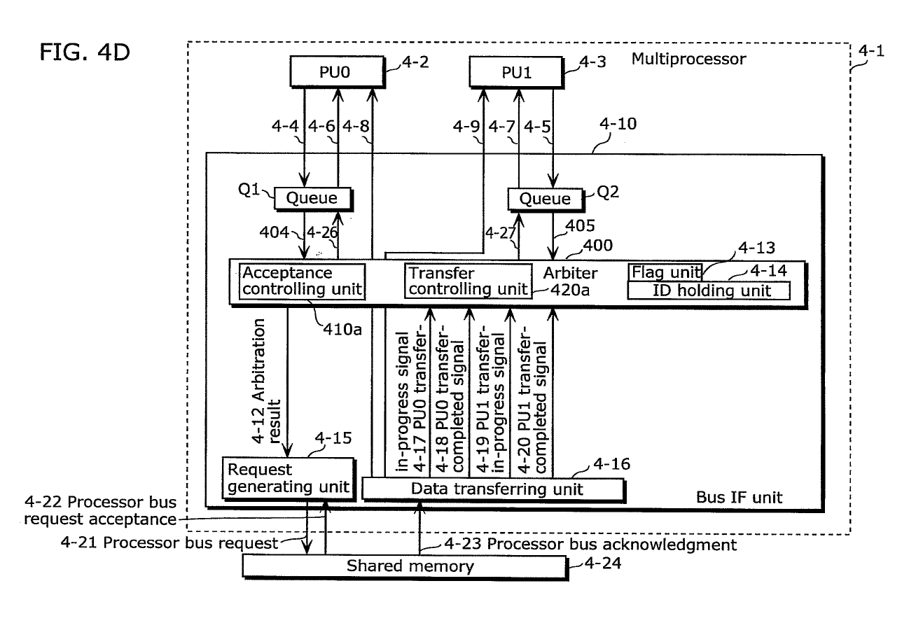

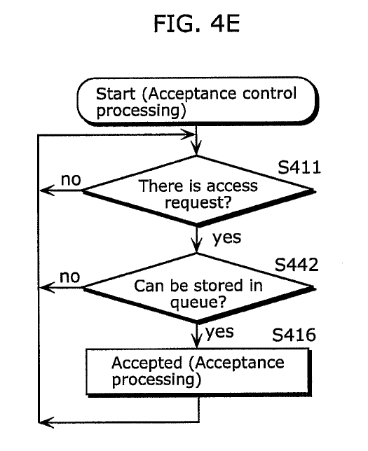

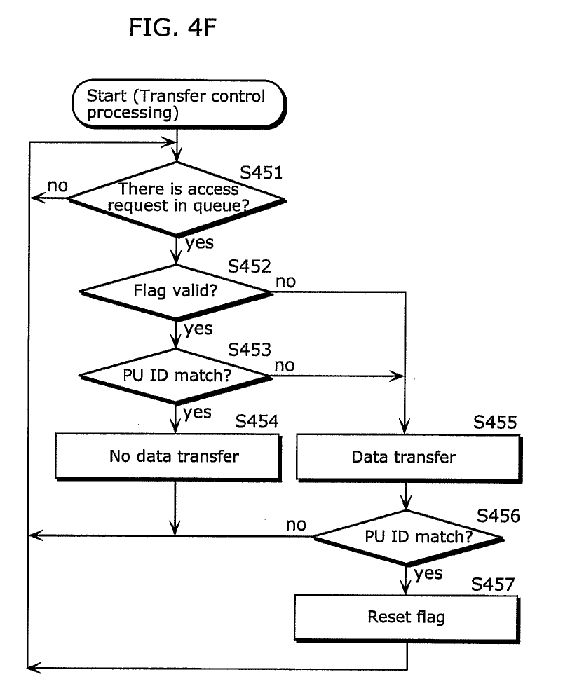

FIG. 4A is a diagram illustrating a structure of the processor system according to the first embodiment of the present invention. The processor system in the figure includes a multiprocessor 4-1 and a shared memory 4-24. In the first embodiment, it is assumed that the multiprocessor 4-1 has two processor units (PU0 and PU1) as plural master units. Via a bus IF unit 4-10, the multiprocessor accesses the shared memory 4-24 connected to a processor bus. Note that the present invention is applicable even to a case, as in FIG. 1, where the shared memory is connected to a shared memory bus shared by other devices (such as DMA, DSP) via a shared memory bus IF unit. Note that the present invention is characterized in enabling LSI designers or programmers who create software to accurately estimate bus access performance. Note also that the advantage of the present invention is significant especially when the present invention is applied to multiprocessors.

The multiprocessor 4-1 has two processor units, namely a PU0 (4-2) and PU1 (4-3), which are identical. Each processor unit includes a CPU which processes instructions and peripheral circuits, and is the minimum structural unit having functions required as a processor, such as an instruction processing function, an interrupt function and a debug function. These processor units are equivalent to the processors.

A bus access request from the PU0 (4-2) is outputted to the bus IF unit 4-10 as a PU0 access request 4-4, and upon accepting the request, the bus IF unit 4-10 sends a PU0 access acceptance 4-6. Next, the bus IF unit 4-10 outputs a processor bus request 4-21 to the shared memory 4-24 connected to the processor bus so as to obtain data, and sends the obtained data and a PU0 acknowledgment 4-8 to the PU0 (4-2). In a similar manner, the PU1 (4-3) accesses the bus through a PU1 access request 4-5, a PU1 access acceptance 4-7, and a PU1 acknowledgment 4-9.

The bus IF unit 4-10 includes an arbiter 400, a request generating unit 4-15, and a data transferring unit 4-16. The bus IF unit 4-10 is a bus interface unit which executes data transfers in a split transaction scheme, and separately executes: the request phase for accepting an access request issued by the plural master units (PU0 and PU1 in the present embodiment); and the transfer phase for executing data transfer via a bus between the shared memory 4-24 and the master units in response to the accepted access request.

Further, in the present embodiment, the bus IF unit 4-10 is structured in such a manner that in the case where one of the master units consecutively issues plural access requests without an interval of a predetermined time period, the number of consecutive executions of the transfer phase corresponding to the plural access requests is restricted to be not more than N. Here, the predetermined time period is equivalent to a part of or an entire time period from when an immediately previously issued access request is accepted, to when the transfer phase corresponding to the immediately previously issued access request is completed.

The arbiter 400 includes an acceptance controlling unit 410, a transfer controlling unit 420, a flag unit 4-13, and an identification (ID) holding unit 4-14.

The acceptance controlling unit 410 controls the acceptance of access requests in the request phase. To be more specific, the acceptance controlling unit 410 accepts the PU0 access request 4-4 and the PU1 access request 4-5 through arbitration of these access requests.

The transfer controlling unit 420 controls data transfer in the transfer phase corresponding to the accepted access request. In the case where there is more than one accepted access request, the transfer controlling unit 420 controls data transfer corresponding to the access request corresponding to an arbitration result 4-12 produced by the arbiter 400.

The flag unit 4-13 holds flag information which is valid during the above mentioned predetermined time period. To be specific, the flag information in the present embodiment is a last acceptance PU information valid bit 4-13.

The ID holding unit 4-14 holds identification information of at least one master unit corresponding to an access request which has been accepted but the transfer phase thereof has not yet been completed. To be specific, the identification information in the present embodiment is a last acceptance PU ID (4-14).

The request generating unit 4-15 accesses the shared memory 4-24 via the processor bus by generating a processor bus request 4-21 and sending the generated processor bus request 4-21 to the processor bus.

When the shared memory 4-24 becomes able to accept the processor bus request 4-21, it sends a processor bus request acceptance 4-22 to the request generating unit 4-15. Then, the shared memory 4-24 sends requested data in the shared memory 4-24 and a processor bus acknowledgment 4-23 to the bus IF unit 4-10. The data transferring unit 4-16 in the bus IF unit 4-10 obtains data sent from the shared memory, and sends the obtained data to the PU which has requested the data access to the shared memory 4-24.

The arbiter 400 sets the last acceptance PU ID (4-14) every time a request is accepted from one of the PUs. For example, when the PU0 access request 4-4 is accepted, the arbiter 400 sets “PU0” as the last acceptance PU ID (4-14). Furthermore, the arbiter 400 also sets the last acceptance PU information valid bit 4-13 which indicates that the information is valid.

Into the arbiter 400, the data transferring unit 4-16 inputs a PU0 transfer-in-progress signal 4-17 and a PU0 transfer-completed signal 4-18. The PU0 transfer-in-progress signal 4-17 indicates that the processor bus request 4-21 sent from the request generating unit 4-15 corresponds to the PU0 (4-2), and continues to be asserted from the cycle at which the processor bus request acceptance 4-22 corresponding to the request has been received, until when all the data transfer corresponding to the request is completed. In other words, the PU0 transfer-in-progress signal 4-17 indicates, when the PU0 (4-2) makes bus access, that the data transfer brought about by the bus access is in progress. The PU0 transfer-completed signal 4-18 is asserted at the last cycle of the transfer, and indicates that the transfer is completed. Similarly, a PU1 transfer-in-progress signal 4-19 and a PU1 transfer-completed signal 4-20 are also outputted for the bus access of the PU1 (4-3).

The last acceptance PU information valid bit 4-13 is set when the request arbitrated by the arbiter 400 is accepted. At the same time, the last acceptance PU ID (4-14) is set to validate the information. The last acceptance PU information valid bit 4-13 and the last acceptance PU ID (4-14) are set every time the arbiter 400 accepts a request. The last acceptance PU information valid bit 4-13 is cleared when the transfer for the last acceptance PU ID (4-14) is completed. For example, in the case where the last acceptance PU ID (4-14) is “PU0”, the last acceptance PU information valid bit 4-13 is set while the PU0 transfer-in-progress signal 4-17 is asserted by the data transferring unit 4-16, and thus indicates that the last acceptance PU ID (4-14) is valid. However, the last acceptance PU information valid bit 4-13 is cleared when the PU0 transfer-completed signal 4-18 is asserted, and as a result, the last acceptance PU ID (4-14) is invalidated. In other words, the last acceptance PU ID (4-14) is validated when the arbiter 400 accepts a request, and holds valid information until when a new request is accepted or until when the data transfer corresponding to the accepted request is completed.

The arbiter 400 judges whether or not to accept a request from the processor units based on the information of the last acceptance PU information valid bit 4-13 and the last acceptance PU ID (4-14).

With such a structure as described above, the present invention prevents the same processor from consecutively accessing the shared bus without an interval of bus cycles, and thus equally distributes the bus performance among processors in the multiprocessor. To be more specific, in the case where both processors make bus access, the bus access to the processor bus by the processors takes place alternately so that the adverse impact of the arbitration and the band width are equalized among the processors. For this, while the last acceptance PU information valid bit 4-13 is not set, that is, when none of the processor units (PU) is currently making bus access, the arbiter 400 accepts a request asserted through the PU0 access request 4-4 or the PU1 access request 4-5.

While the last acceptance PU information valid bit 4-13 is set, that is, when one of the PUs is currently making bus access, the arbiter 400 accepts only the request of the PU that is different from the PU number set in the last acceptance PU ID (4-14). The request from the same PU as the PU set in the last acceptance PU ID (4-14) is not accepted even if it is asserted.

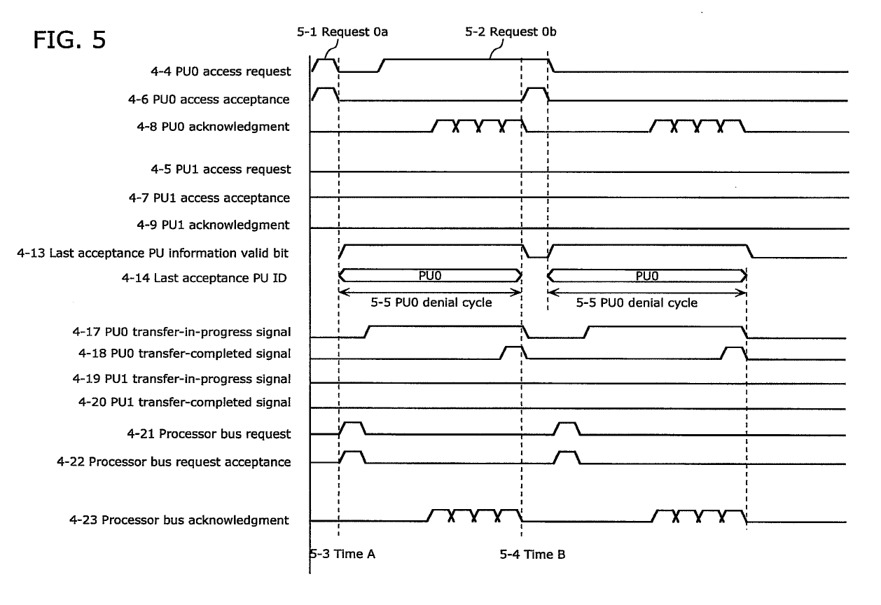

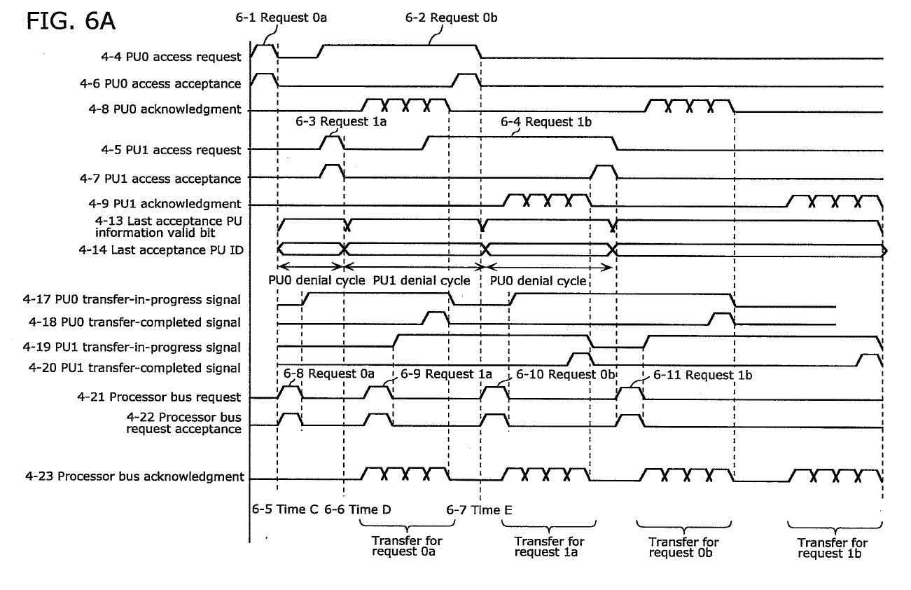

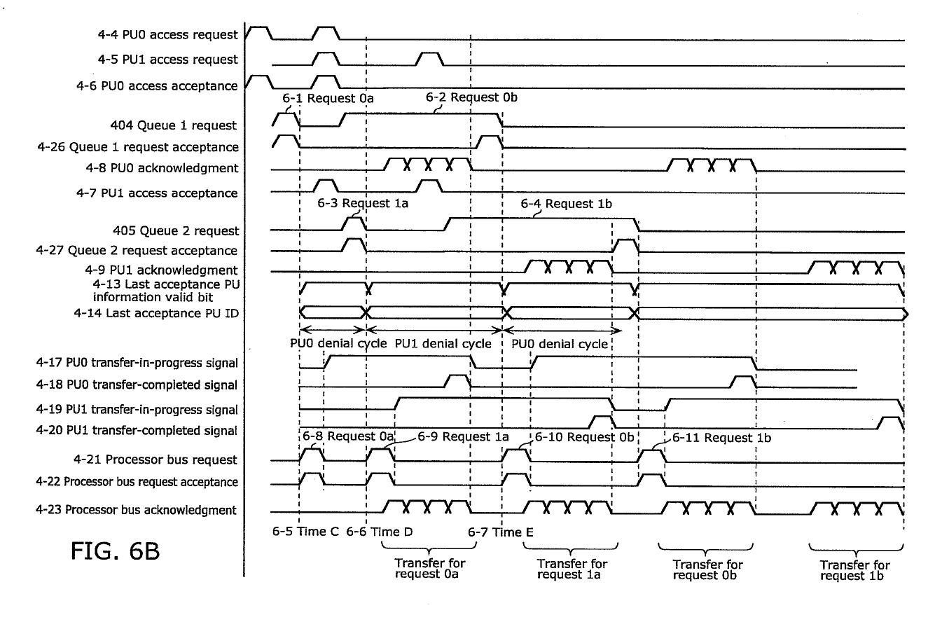

With FIG. 5 and FIG. 6A illustrating operational timings, the further detailed description shall be provided below.

FIG. 5 illustrates the case where two requests are consecutively asserted by the PU0 (4-2) and no request is asserted by the PU1 (4-3). More specifically, the PU0 (4-2) asserts a request 0a (5-1) and a request 0b (5-2).

At first, the request 0a (5-1) is asserted and the bus IF unit 4-10 accepts it. Since the request is accepted, the last acceptance PU information valid bit (4-13) is set at the timing A (5-3). At the same time, “PU0” is set as the last acceptance PU ID (4-14). In this state, the arbiter 400 does not accept the PU0 access request 4-4 even if it is asserted. To be more specific, the request 0b (5-2) is not accepted until when the bus access corresponding to the request 0a (5-1) is completed (PU0 denial cycle 5-5). Consequently, the request 0b (5-2) continues to be asserted.

When the bus access corresponding to the request 0a (5-1) is completed at the timing B (5-4), the PU0 transfer-completed signal 4-18 is asserted and the last acceptance PU information valid bit 4-13 is cleared. This is a state where the request from the PU0 (4-2) can be accepted, and thus the next request 0b (5-2) which has continued to be asserted is accepted.

FIG. 6A illustrates the case where both the PU0 (4-2) and the PU1 (4-3) make plural bus access requests. More specifically, the PU0 (4-2) asserts a request 0a (6-1) and a request 0b (6-2), and the PU1 (4-3) asserts a request 1a (6-3) and a request 1b (6-4) at the timings shown in FIG. 6A.

At first, the request 0a (6-1) is asserted. Since none of the PUs is making bus access at the timing C (6-5), the bus IF unit (4-10) accepts this request. Since the request is accepted, the last acceptance PU information valid bit (4-13) is set. At the same time, “PU0” is set as the last acceptance PU ID (4-14). In this state, the arbiter 400 does not accept the PU0 access request 4-4 even if it is asserted (PU0 denial cycle). At the timing D (6-6), the request 0b (6-2) is asserted, however, it is not accepted because: the transfer corresponding to the request 0a (6-1) is not completed yet; the last acceptance PU information valid bit (4-13) is still set; and the last acceptance PU ID (4-14) is “PU0”. In this state, the arbiter (400) only accepts the PU1 access request (4-5). Consequently, the request 0b (6-2) continues to be asserted.

When the request 1a (6-3) is outputted, the arbiter (400) accepts this request, since the request 1a (6-3) is asserted by the PU1 (4-3), although it is outputted at a later timing than that of the request 0b (6-2). Then at the timing D (6-6), the arbiter (400) re-sets the last acceptance PU information valid bit (4-13) and sets the last acceptance PU ID (4-14) to “PU1”. In this state, the arbiter (400) does not accept the PU1 access request (4-5) from the PU1 (4-3), since the last acceptance PU ID (4-14) is “PU1”. Consequently, the request 1b (6-4) subsequently asserted by the PU1 (4-3) is not accepted.

On the other hand, the PU0 access request (4-4) from the PU0 (4-2) can be accepted because the last acceptance PU ID (4-14) is “PU1”. In the present embodiment, the arbiter 400 can accept only one request after the request for which data transfer is in progress. Therefore, in FIG. 6A, at the point of time when the request 1a (6-3) is accepted from the PU1 (4-3), the arbiter 400 can accept the request 0b (6-2) which is being asserted by the PU0 (4-2). However, because the request 1a (6-3) has already been accepted in addition to the request 0a (6-1) for which the transfer is in progress, the arbiter 400 accepts the request 0b (6-2) at the timing E (6-7) at which the transfer corresponding to the request 0a (6-1) is completed. At the timing E (6-7), the next request 1b (6-4) is already being asserted by the PU1 (4-3), however, instead of this request, the request 0b (6-2) is accepted because the timing E (6-7) is in the PU1 denial cycle. To put it differently, it can be said that the arbiter 400 determines which request, that is, either the request from the PU0 (4-2) or the request from the PU1 (4-3) is to be accepted at the timing E (6-7) at which the next request from one of the processor units can be accepted, based on the values of the last acceptance PU information valid bit 4-13 and the last acceptance PU ID (4-14). Note that when the structure is such that two or more subsequent requests can be accepted by having, for example, a request queue (buffer) structured as a FIFO within the bus IF unit 4-10, the request 0b (6-2) from the PU0 (4-2) can be immediately accepted without having to wait for the timing E (6-7), because the request from the PU0 (4-2) can be accepted when the last acceptance PU ID (4-14) is re-set to “PU1”. Then, the actual transfer processing is performed in the order in which the requests are accepted.

The request 0b (6-2) is accepted at the timing E (6-7), and thus, again, the last acceptance PU information valid bit (4-13) is set, and the last acceptance PU ID (4-14) is set to “PU0”. In this state, the PU0 access request (4-4) cannot be accepted. On the other hand, the request 1b (6-4) from the PU1 (4-3) can be accepted. Therefore, the arbiter 400 accepts the request 1b (6-4) at the timing when the transfer corresponding to the request 1a (6-3) is completed. As a matter of course, in the case where the structure is such that two or more subsequent requests can be accepted, the request 1b (6-4) may be accepted at the timing when the last acceptance PU ID (4-14) is set to “PU0”.

Since the arbiter 400 accepts requests in the order as described above and sequentially generates processor bus requests 4-21, the access to the shared memory 4-24 takes place in the alternate order of PU0 (4-2) and the PU1 (4-3). In other words, requests are sequentially accepted in the following order: the request 0a (6-1), the request 1a (6-3), the request 0b (6-2), and the request 1b (6-4), and the bus access takes place in the following order: the processor bus request 0a (6-8), the processor bus request 1a (6-9), the processor bus request 0b (6-10), and the processor bus request 1b (6-11). As a result, the bus conflict and the transfer status affect each PU almost proportionally. Thus, although the latency and the transfer completion cycle of each access may be longer in some cases compared to when the requests are consecutively accepted and the bus is accessed consecutively, it is possible to equally distribute the adverse impact of the conflict among the two processor units, since the processor units make bus access alternately.

FIG. 4B is a flow chart illustrating an example of acceptance control processing performed by the acceptance controlling unit 410. As the figure shows, when a new access request is issued by the PU0 or the PU1 (S411), at first, the acceptance controlling unit 410 judges whether or not the new access request can be stored in an internal buffer (S412). Here, for simplification of the description as in FIGS. 5 and 6A, it is assumed that the acceptance controlling unit 410 has an acceptance buffer for storing one access request, and that the transfer controlling unit 420 has a transfer buffer for storing one access request.

In the case where the new access request can be stored (in the case where the acceptance buffer has space), the acceptance controlling unit 410 judges whether flag information (the last acceptance PU information valid bit 4-13) is valid or invalid (S413), and accepts the new access request when the flag information indicates invalid (S416). The new access request is accepted, because this is not the case of a single PU consecutively making bus access.

In the acceptance processing in S416, the acceptance controlling unit 410 stores the new access request in the internal acceptance buffer (S421), sets the corresponding PU ID in the ID holding unit 4-14 (S422), and validates (sets) the flag information held by the flag unit 4-13 (the last acceptance PU information valid bit 4-13) (S423).

Further, in the case where the flag information is valid, the acceptance controlling unit 410 judges whether or not the identification information of the PU which has issued the new access request (PU ID) and the identification information held by the ID holding unit (PU ID) match each other (S414), and accepts the new access request when the identification information do not match each other (S416). The new access request is accepted, because this is also not the case of a single PU consecutively making bus access.

Furthermore, in the case of judging that the identification information match each other, the acceptance controlling unit 410 does not accept the new access request (S415). In this case, the flag information being valid denotes that the access request has been issued without the interval of the above mentioned predetermined time period. The match of the identification information denotes that the new access request and the previous access request have been issued from the same PU. Since the new access request is not accepted in S415, the acceptance of this new access request delays until the flag information becomes invalid. Until then, a new access request issued from the other PU will be accepted.

FIG. 4C is a flow chart illustrating an example of transfer control processing performed by the transfer controlling unit 420. As the figure shows, in the case where the above mentioned transfer buffer has space and there is an access request stored in the acceptance buffer (S431), the transfer controlling unit 420 moves the access request from the acceptance buffer to the transfer buffer and executes data transfer in response to the access request (S432). When the data transfer is completed, the transfer controlling unit 420 judges whether or not the identification information of the PU corresponding to the new access request (PU ID) and the identification information held by the ID holding unit (PU ID) match each other (S433). In the case where the identification information match each other, the transfer controlling unit 420 invalidates (resets) the flag information (the last acceptance PU information valid bit 4-13) held by the flag unit 4-13 and clears the PU ID held by the ID holding unit 4-14 (S434). Here, the clearing of the PU ID held by the ID holding unit 4-14 may be omitted.

In the present embodiment, there are two processor units. Note, however, that similar advantages can be obtained even with two or more processor units, given that there are plural last acceptance PU information valid bits and last acceptance PU IDs and such restriction as described above is imposed on each of the processors.

Furthermore, in the present embodiment, once an access request from a particular processor unit is accepted, another request from the same processor unit is not consecutively accepted until the processing corresponding to the accepted request is completed. However, even with a structure of the processor system in the following variation, it is possible to obtain similar advantages.

FIG. 4D is a block diagram illustrating an example of a processor system structure according to a variation of the first embodiment. This figure is different from FIG. 4A in that queues Q1 and Q2 which are capable of distinguishing requests of each processor are added to the bus IF unit 4-10, and in that an acceptance controlling unit 410a and a transfer controlling unit 420a are included instead of the acceptance controlling unit 410 and the transfer controlling unit 420. Hereinafter, the common aspects are omitted from the following description, and basically the different aspects shall be described.

The queues Q1 and Q2 are buffers for accepting the access requests from the PU0 and the PU1 in advance, respectively. The queues Q1 and Q2 are capable of holding at least one access request. For convenience of the description, it is assumed here that the queues Q1 and Q2 are both capable of holding one access requests respectively.

The acceptance controlling unit 410 accepts, in advance, the access requests from the PU0 and the PU1 into the queues Q1 and Q2, respectively, regardless of the validity of the flag information.

The transfer controlling unit 420a determines from which one of the queues an access request is to be issued as a processor bus request. In this case, the last acceptance PU information valid bit 4-13 and the last acceptance PU ID (4-14) are set at the timing when the bus IF unit 4-10 asserts a processor bus request (4-21) to the processor bus, instead of at the timing when the access request from a processor unit is accepted.

FIG. 6B is a diagram illustrating access timings according to the variation of the first embodiment. This figure is different from FIG. 6A mainly in that: a queue 1 request 404 and a queue 2 request 405 are added; the PU0 access request 4-4 and the PU1 access request 4-5 are accepted at different timings (that is, the PU0 access acceptance 4-6 and the PU1 access acceptance 4-7 are asserted at different timings); and the PU0 access acceptance 4-6 and the PU1 access acceptance 4-7 are outputted from the queues Q1 and Q2, respectively, instead of being outputted from the arbiter 400.

The PU0 access request 4-4 is immediately accepted if the queue Q1 has space. In the figure, it is accepted at the cycle when the PU0 access request 4-4 is asserted. A statement similar to the above can be made for the PU1 access request 4-5 in relation to the queue Q2.

The queue 1 request 404 is a signal indicating that the accepted access request is held in the queue Q1, and is negated when transferred to the acceptance buffer in the arbiter 400. A statement similar to the above can be made for the queue 2 request 405 in relation to the queue Q2.

A queue 1 request acceptance 4-26 is a signal asserted when an access request is transferred to the acceptance buffer from the queue Q1, which takes place when the queue 1 request 404 is asserted and the acceptance controlling unit 410a in the arbiter 400 is able to accept an access request (in the case where the acceptance buffer has space). A statement similar to the above can be made for a queue 2 request acceptance 4-27.

From the viewpoint of the arbiter 400, the queues Q1 and Q2 are equivalent to the master units (PU0 and PU1, respectively) in the request phase shown in FIG. 4A. Further, from the viewpoint of the master units, the queues Q1 and Q2 are equivalent to the arbiter 400 (the acceptance controlling unit 410a) in the request phase.

As stated above, by having the queues Q1 and Q2 between the master units (PU0 and PU1) and the arbiter 400, there is a less number, from the viewpoint of the master units, of access requests waiting to be accepted in the request phase, and thus the access requests can be accepted sooner. With this, the number of consecutive executions of the transfer phase of a single master unit is restricted by delaying the start timing of the transfer phase after an access request is accepted, instead of by rejecting (delaying) to accept the access request in the request phase.

In FIG. 6B, the number of consecutive executions of the transfer phase of a single master unit is restricted through the transfer control processing in which the transfer controlling unit 420a controls the timing at which the transfer phase starts, instead of being restricted through the acceptance control processing in the request phase.

FIG. 4E is a flow chart illustrating an example of the acceptance control processing performed by the acceptance controlling unit 410a in the present variation. This figure is different from FIG. 4B in that Steps S412 to S415 are removed and S442 is added. Hereinafter, the common aspects are omitted from the following description, and basically the different aspects shall be described.

When a new access request is issued, in the case where the corresponding queue Q1 or the queue Q2 has space (S442), the acceptance controlling unit 410a accepts the access request into the corresponding queue Q1 or the queue Q2 (S416). As a result, when the PU0 and the PU1 consecutively issue access requests, the access requests are accepted at timings earlier than that in FIG. 4B.

FIG. 4F is a flow chart illustrating an example of transfer control processing performed by the transfer controlling unit 420a in the present variation. In the figure, in the case where there is an access request stored in the queue Q1 or the queue Q2 (S451), the transfer controlling unit 420a judges whether the flag information (the last acceptance PU information valid bit 4-13) is valid or invalid (S452). When the flag information is invalid, the transfer controlling unit 420a executes data transfer (the transfer phase) in response to the new access request (S455). The data transfer is executed, because this is not the case of a single PU consecutively making bus access.

Further, in the case where the flag information is valid, the transfer controlling unit 420a judges whether or not the identification information of the PU corresponding to the access request stored in the queue (PU ID) and the identification information held by the ID holding unit (PU ID) match each other (S453). When the identification information match each other, the transfer controlling unit 420a does not execute data transfer in response to the new access request (S454). The data transfer is not executed, because this is the case of a single PU consecutively making bus access. The data transfer for this access request is delayed until the flag information is reset. During the delay of the data transfer, data transfer for an access request from the other PU is executed, if there is such an access request.

Further, in the case where the flag information is valid, the transfer controlling unit 420a judges whether or not the identification information of the PU corresponding to the access request held in the queue (PU ID) and the identification information held by the ID holding unit (PU ID) match each other (S453), and executes the data transfer in response to the new access request when the identification information do not match each other (S455). The data transfer is executed, because this is not the case of a single PU making consecutively making bus access.

When the data transfer is completed, the transfer controlling unit 420a judges whether or not the identification information of the PU corresponding to the new access request (PU ID) and the identification information held by the ID holding unit (PU ID) match each other (S456). In the case where the identification information match each other, the transfer controlling unit 420a invalidates (resets) the flag information (the last acceptance PU information valid bit 4-13) held by the flag unit 4-13 and clears the PU ID held by the ID holding unit 4-14 (S457). Here, the clearing of the PU ID held by the ID holding unit 4-14 may be omitted.

According to the present variation described above, it is possible to restrict the number of consecutive executions of transfer phase of a single master unit based on the information registered in the queues, without referring to the requests from the master units. Further, the access performance can be equalized based on the simple structure of holding the identification information and the flag information. Besides, from the viewpoint of the master units, the access requests are immediately accepted and thus the time to wait for the acceptance is reduced, which enables a reduction in the processing load on the master units in performing bus accesses.

### Second Embodiment

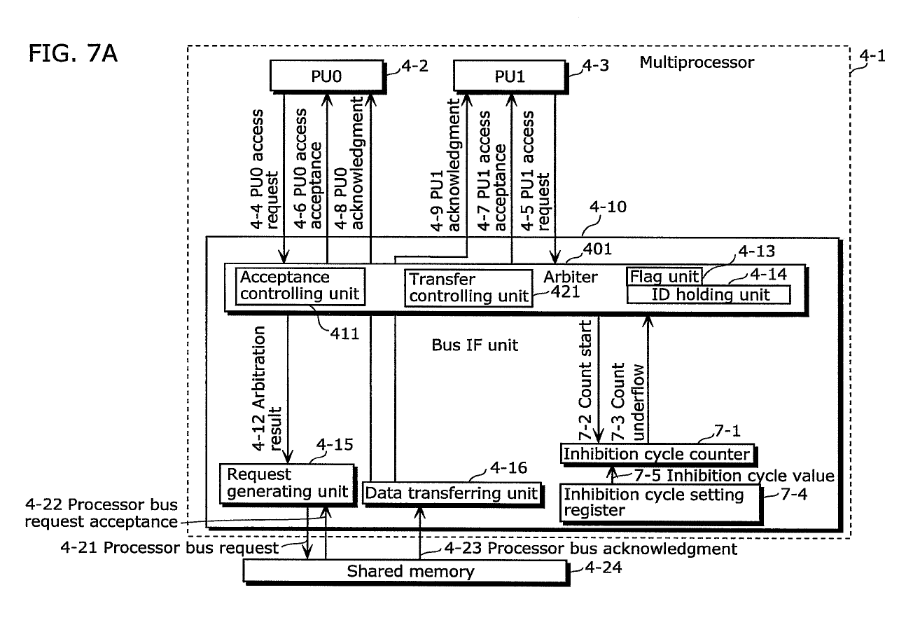

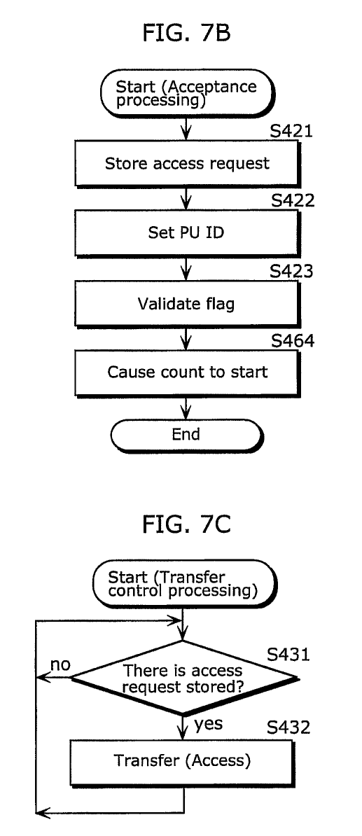

A second embodiment of the present invention shall be described below. FIG. 7A illustrates a system structure according to the second embodiment. In the present embodiment, consecutive bus access by the same processor is controlled to be prohibited during a set time period. The elements which are common to FIG. 4A are given the same reference numbers and the description thereof is omitted.

The bus IF unit 4-10 of FIG. 7A is different from that of FIG. 4A in that the bus IF unit 4-10 of FIG. 7A has an inhibition cycle counter 7-1 which counts a predetermined number of cycles and an inhibition cycle setting register 7-4 which can be set by one of master units and holds the predetermined number of cycles. For example, after loading the cycle number set in the inhibition cycle setting register 7-4, the inhibition cycle counter 7-1 counts down the loaded number of cycles.

Every time an access request is accepted, an acceptance controlling unit 411 performs the following: validates flag information; sets, in the ID holding unit 4-14 identification information corresponding to the access request; and causes the inhibition cycle counter 7-1 to count down the number of cycles.

The flag unit 4-13 invalidates the flag information when the inhibition cycle counter 7-1 has counted the predetermined number of cycles.

FIG. 7B is a flow chart illustrating an example of acceptance control processing performed by the acceptance controlling unit 411 of the present embodiment. The acceptance controlling unit 411 performs acceptance control processing similar to that of FIG. 4B, however the processing of the acceptance controlling unit 411 is different in that the acceptance processing S416 shown on the right side of FIG. 4B is replaced with the acceptance processing shown in FIG. 7B.

In FIG. 7B, when the acceptance controlling unit 411 accepts a request (an access request) from a processor unit (S421), it sets the last acceptance PU information valid bit 4-13 and the last acceptance PU ID (4-14) (S422 and S423), and at the same time, sends a count start (7-2) to the inhibition cycle counter 7-1 (S464). When the inhibition cycle counter 7-1 receives the count start (7-2), the inhibition cycle setting register 7-4 sets an inhibition cycle value 7-5, and the inhibition cycle counter 7-1 counts down the inhibition cycle value 7-5 from the next cycle, every time a clock is inputted. Here, the value of the inhibition cycle setting register 7-4 can be set to any given value by software, and the inhibition cycle setting register 7-4 is, for example a register programmable to be updated through a register writing instruction executed by a processor unit. When the inhibition cycle counter 7-1 becomes underflow, that is, when the count value reaches 0, a count underflow (7-3) is outputted to the flag unit 4-13. As a result, the last acceptance PU information valid bit held by the flag unit 4-13 is invalidated (reset).

FIG. 7C is a flow chart illustrating an example of transfer control processing performed by a transfer controlling unit 421. This figure is different from FIG. 4C in that Steps S433 and S434 are removed. More specifically, the processing for resetting the flag is removed.

In the first embodiment, the last acceptance PU information valid bit held by the flag unit 4-13 is cleared through the PU0 transfer-completed signal 4-18 or the PU1 transfer-completed signal 4-20. Note, however, that in the present embodiment, it is cleared through the count underflow (7-3). Therefore, consecutive requests from the same processor unit are processed, only when the arbiter 401 accepts a request from a different processor unit and re-sets the last acceptance PU ID (4-14), or when the cycle time period set as the inhibition cycle value 7-5 has elapsed and the last acceptance PU information valid bit (4-13) is cleared.

In the present embodiment, with the structure described above, the consecutive bus access by the same processor in a predetermined cycle time period is inhibited so that opportunities are created for the other processor to make bus access, and thus, it is possible to equally distribute the bus access performance.

Note that the present embodiment can be combined with another embodiment. For example, the last acceptance PU information valid bit 4-13 may be cleared also through the PU0 transfer-completed signal 4-18 or the PU1 transfer-completed signal 4-20, in addition to the case where the last acceptance PU information valid bit 4-13 is cleared when the cycle time period set as the inhibition cycle value 7-5 elapses.

### Third Embodiment

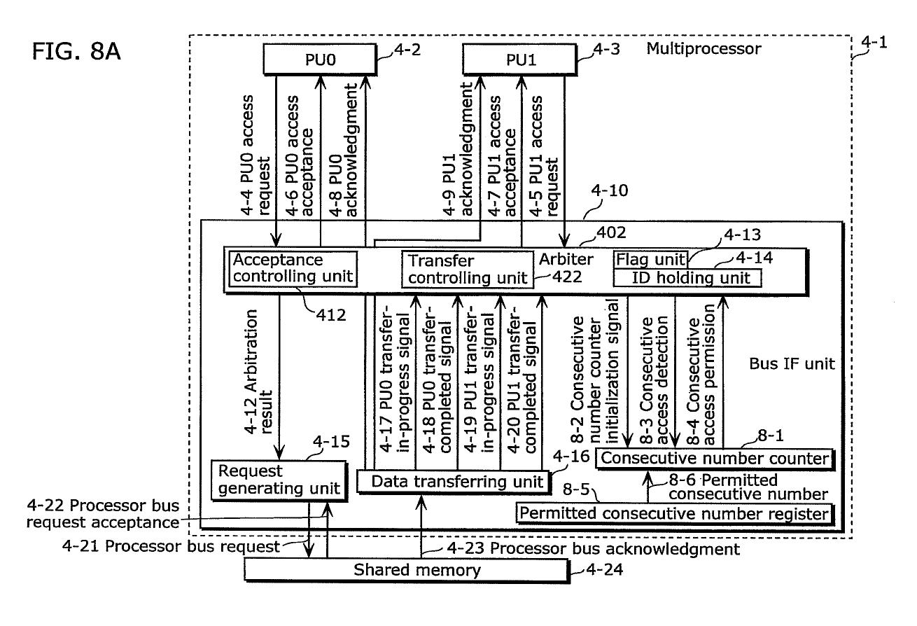

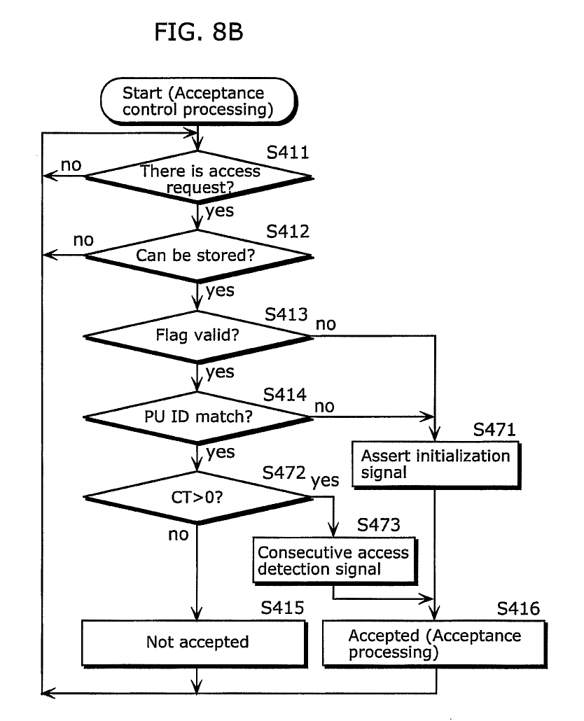

A third embodiment of the present invention shall be described below. FIG. 8A illustrates a system structure according to the third embodiment. In the present embodiment, consecutive bus access by the same processor is controlled in such a manner that consecutive bus access equal to or more than a predetermined number executed by the same processor is inhibited. The bus IF unit 4-10 of FIG. 8A is different from that of FIG. 4A in that the bus IF unit 4-10 of FIG. 8A has a permitted consecutive number register 8-5 which can be set by one of master units and holds the permitted number of consecutive transfers N, and a consecutive number counter 8-1 which counts the permitted number of consecutive transfers N. For example, after loading the number N held by the permitted consecutive number register 8-5, the consecutive number counter 8-1 counts down the loaded number N. The elements which are common to FIG. 4A are given the same reference numbers and the description thereof is omitted.

FIG. 8B is a flow chart illustrating an example of acceptance control processing performed by an acceptance controlling unit 412. This figure is different from FIG. 4B in that Steps S471 to S473 are added. Hereinafter, the common aspects are omitted from the following description, and basically the different aspects shall be described.

When a new access request is issued, the acceptance controlling unit 412 asserts an initialization signal to the consecutive number counter 8-1 (S471) and accepts the new access request (S416) when one of the following cases applies: when flag information is invalid (S413: no); and when the flag information is valid and it is judged that the PU ID of the master unit which has issued the access request and the PU ID held by the ID holding unit 4-14 do not match each other (S414: no). Since the initialization signal is asserted, the consecutive number counter 8-1 loads, as initialization, the permitted number of consecutive transfers N held by the permitted consecutive number register 8-5. With this, the consecutive number counter 8-1 is initialized when a new access request does not represent access consecutively made by a single PU.

Furthermore, when the PU ID of the master unit which has issued the access request and the PU ID held by the ID holding unit 4-14 match each other (S414: yes), the acceptance controlling unit 412 judges whether or not the consecutive number counter 8-1 has counted N times (count value CT>0?) (S472). In the case where it is judged that the consecutive number counter 8-1 has not counted N times, the acceptance controlling unit 412 asserts a consecutive access detection signal to the consecutive number counter 8-1 (S473), and accepts the new access request (S416). Since the consecutive access detection signal is asserted, the consecutive number counter 8-1 counts −1.

Further, in the case where it is judged that the consecutive number counter 8-1 has counted N times (S472: no), the acceptance controlling unit 412 does not accept the new access request (S415).

In the present embodiment, when the arbiter 402 accepts a request while the acceptance PU information valid bit 4-13 is not set, it sets the acceptance PU information valid bit 4-13 and the last acceptance PU ID 4-14, and at the same time asserts a consecutive number counter initialization signal 8-2 to the consecutive number counter 8-1. When the consecutive number counter initialization signal 8-2 is accepted, the permitted consecutive number register 8-5 sets a permitted consecutive number 8-6 in the consecutive number counter 8-1. Here, the value of the permitted consecutive number register 8-5 can be set to any given value by software, and the permitted consecutive number register 8-5 is, for example a register programmable to be updated through a register writing instruction executed by a processor unit.

When the arbiter 402 accepts the next request, it judges whether or not the last acceptance PU information valid bit 4-13 is set. In the case where it is judged that the last acceptance PU information valid bit 4-13 is set, the arbiter 402 refers to the information of the last acceptance PU ID (4-14). In the case where the held information is the same as the accepted processor information, the arbiter 402 inputs the consecutive access detection signal 8-3 to the consecutive number counter 8-1. The consecutive number counter 8-1 receives this signal and performs the count down. In the cases other than the above, the consecutive number counter initialization signal 8-2 is outputted, and the permitted consecutive number 8-6 is set again in the consecutive number counter 8-1.

When the consecutive number counter 8-1 indicates a value equal to or greater than 0, it is judged that the bus access can be executed even when it is bus access consecutively made by the same processor, and thus the consecutive number counter 8-1 inputs a consecutive access permission signal 8-4 to the arbiter 402. While the consecutive access permission signal 8-4 is inputted, the arbiter 402 accepts requests from both processor units. However, when the consecutive number counter 8-1 becomes underflow, that is, when the count value reaches 0, no more access request from the same processor is consecutively accepted.

In the present embodiment, with the structure described above, the consecutive accesses equal to or more than a predetermined number are inhibited, so that it is possible to reduce the situation where frequent consecutive accesses made by the same processor hinder requests of the other processor from getting accepted.

Note that the present embodiment can be combined with another embodiment. For example, the multiprocessor may further have an inhibition cycle counter to inhibit consecutive accesses which are equal to or greater than the predetermined number in a predetermined cycle time.

### Fourth Embodiment

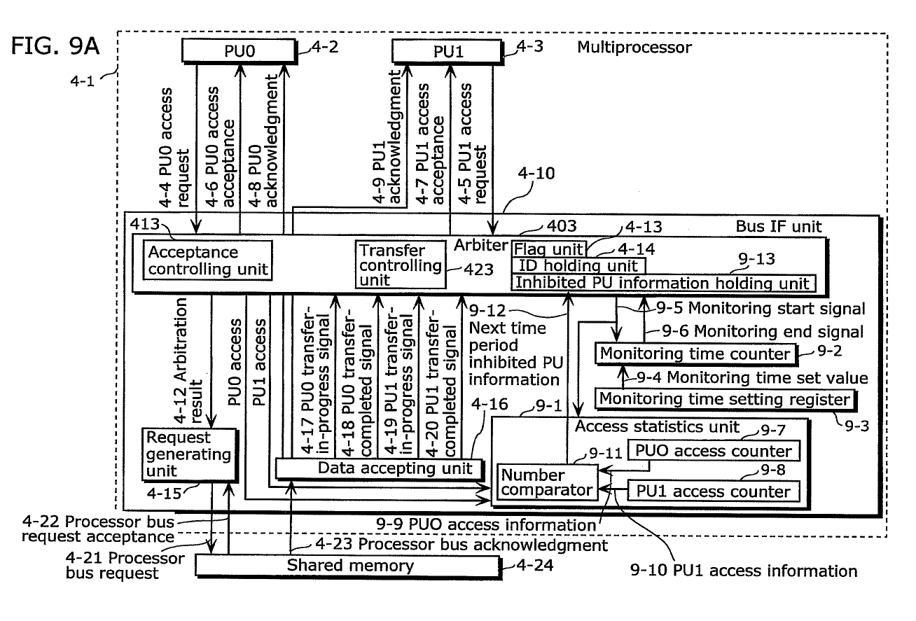

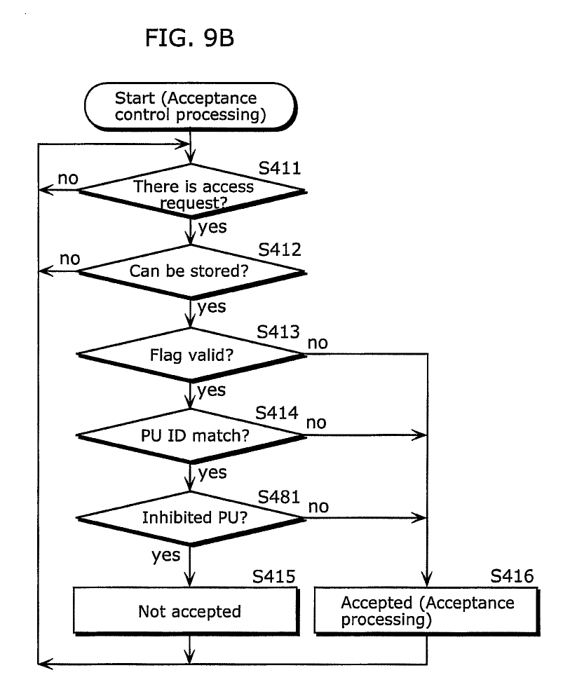

A fourth embodiment of the present invention shall be described below. FIG. 9A illustrates a system structure according to the fourth embodiment. In the present embodiment, the bus access status of each processor is always monitored in a particular cycle time period and the processor which makes bus access a greater number of times in the cycle time period is controlled in the next cycle time period in a manner similar to the control described in the first embodiment. The bus IF unit 4-10 of FIG. 9A is different from that of FIG. 4A in that an inhibited PU information holding unit 9-13, a monitoring time counter 9-2, a monitoring time setting register 9-3, and an access statistics unit 9-1 are added. The elements which are common to FIG. 4A are given the same reference numbers and the description thereof is omitted.

The inhibited PU information holding unit 9-13 functions as the second identification information holding unit which holds, as the second identification information, identification information (PU ID) of a master unit among the plural master units whose number of consecutive transfer phase executions is to be restricted.

The monitoring time counter 9-2 periodically counts a monitoring time period (a fixed time period) set by the monitoring time setting register 9-3.

The access statistics unit 9-1 functions as the counting unit which counts, for every fixed time period, how many times each master unit makes bus access. The access statistics unit 9-1 includes: a PU0 access counter 9-7 which counts how many times the PU0 makes bus access in the fixed time period; a PU1 access counter 9-8 which counts how many times the PU1 makes bus access in the fixed time period; and a number comparator 9-11 which functions as the setting unit that sets in the second identification information holding unit the identification information of the master unit which has accessed the bus the greatest number of times, as the second identification information.

FIG. 9B is a flow chart illustrating an example of acceptance control processing performed by an acceptance controlling unit 413. This figure is different from FIG. 4B in that Step S481 is added between Step S414 and Steps S415 and S416. More specifically, the acceptance controlling unit 413 accepts a new access request (S416) in the case where it judges in S481 that a PU ID corresponding to the new access request and an inhibition PU ID (the second identification information) do not match each other, and does not accept the new access request in the case where it is judged that the PU IDs match each other (S415).

The access statistics unit 9-1 is a block which analyzes how many times each processor has made access in any given cycle time period. The cycle time period is programmable to be set by the monitoring time counter 9-2 and the monitoring time setting register 9-3. The monitoring time counter 9-2 is a counter that performs count-down when a clock is inputted. When a monitoring start signal 9-5 is inputted, the monitoring time counter 9-2 loads a monitoring time set value 9-4 which has been set by the monitoring time setting register 9-3. Thus, the loaded monitoring time set value 9-4 is set as the initial value for the count-down. When the count value of the monitoring time counter 9-2 reaches 0, it is judged that the monitoring time period has elapsed, and thus a monitoring end signal 9-6 is asserted. The above represents a counting operation in a single monitoring time period. When the monitoring end signal 9-6 is asserted, the monitoring start signal 9-5 is asserted at the same time or at a following predetermined timing so that the counting operation in a monitoring time period is repeated again. Here, the value of the monitoring time setting register 9-3 can be set to any given value by software, and the monitoring time setting register 9-3 is, for example, a register programmable to be updated through a register writing instruction executed by a processor unit.

When the monitoring start signal 9-5 is asserted, the values of the PU0 access counter 9-7 and the PU1 access counter 9-8 of the access statistics unit 9-1 are cleared to be 0. After that, every time the arbiter 403 accepts a request from one of the processor units, when the accepted request is a request from the PU0 (4-2), PU0 access information is sent to the PU0 access counter 9-7 which thus counts +1. In a similar manner, in the case where the accepted request is a request from the PU1 (4-3), PU1 access information is sent to the PU1 access counter 9-8 which thus counts +1. When the monitoring end signal 9-6 is asserted to the access statistics unit 9-1, the number comparator 9-11 compares the value of the PU0 access counter 9-7 and the value of the PU1 access counter 9-8, and information about the processor unit with a greater number is set to be inhibited PU information 9-13 as next time period inhibited PU information 9-12.

The operations of the last acceptance PU information valid bit 4-13 and the last acceptance PU ID (4-14) are similar to that of the first embodiment.

The present embodiment is characterized in that the inhibited PU information 9-13 is also referred to, in addition to the last acceptance PU information valid bit 4-13 and the last acceptance PU ID (4-14). In the case where the processor unit which has issued the next request is the same as the processor unit indicated in the inhibited PU information 9-13, the access control is performed according to the last acceptance PU information valid bit 4-13 and the last acceptance PU ID (4-14). However, in the case where the processor unit which has issued the next request is different from the processor unit indicated in the inhibited PU information 9-13, the request from the processor unit is accepted. To put it differently, in the case where a request from the PU0 (4-2) is asserted when both the last acceptance PU ID (4-14) and the inhibited PU information 9-13 indicate “PU0” and the last acceptance PU information valid bit 4-13 is set, this request is not accepted. However, in the case where the request from the PU0 (4-2) is asserted when one of the last acceptance PU ID (4-14) and the inhibited PU information 9-13 indicates “PU1”, this request is accepted. This is a series of operations repeated for every monitoring time set value 9-4.

In the present embodiment, with the above described structure, the bus access information of each processor is obtained in a predetermined time period and consecutive access from the processor which has accessed the bus a greater number of times in the previous time period is inhibited in the next time period, which makes it possible to reduce the adverse impact of the processor making frequent access on the other processor, and thus possible to equally distribute the bus access performance among all the processors in all time periods.

Further, it is needless to state that the present embodiment can be applied not only to the first embodiment but also to another embodiment or a combination of embodiments.

### Fifth Embodiment

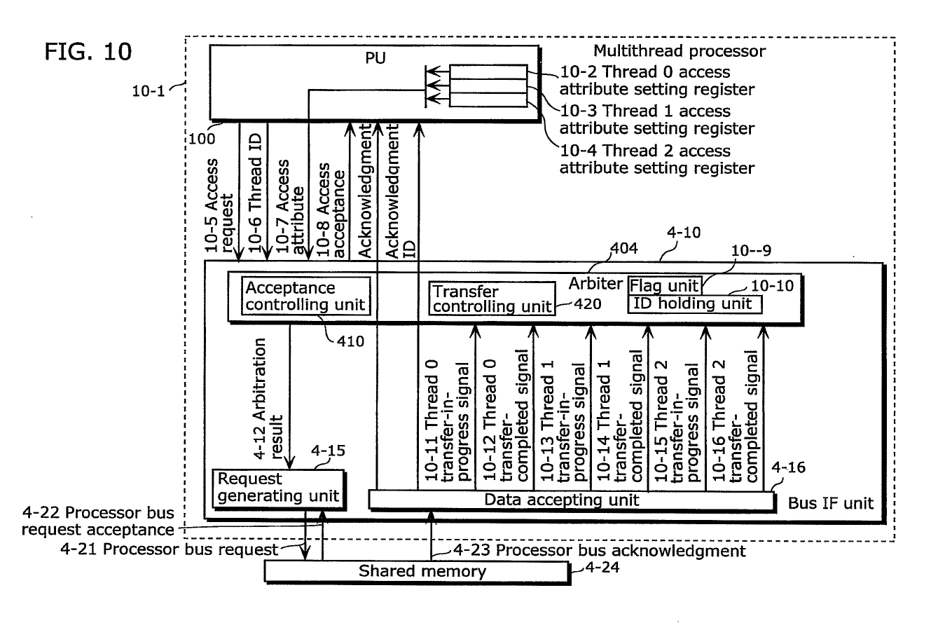

A fifth embodiment of the present invention shall be described below. FIG. 10 illustrates a system structure according to the fifth embodiment. In the present embodiment, the processor does not have to be a multiprocessor having a plurality of cores, and it is, in the present embodiment, a multithread processor which can simultaneously operate a plurality of threads. To be more specific, the multithread processor in the present embodiment has such a structure that each thread can independently issue a bus access request and can also issue a bus access request even when a bus access by another thread is in progress.

Even with such a multithread processor, a problem similar to the above described multiprocessor problem arises, and there are cases where it is desired to prevent the bus access performance stemming from a particular thread. More specifically, even with the multithread processor, there are cases where it is desired to equally allocate the bus band width to each thread and to equally allocate, to each thread, the adverse impact of the bus access caused by conflicts.

A multithread processor 10-1 is a processor capable of processing three threads (a thread 0, a thread 1, and a thread 2). The multithread processor 10-1 is capable of setting the types of bus access made by the thread 0, the thread 1, and the thread 2, to a thread 0 access attribute setting register 10-2, a thread 1 access attribute setting register 10-3, and a thread 2 access attribute setting register 10-4, respectively. When bus access by a thread occurs, a thread ID (10-6) of the thread which has issued the request and an access attribute 10-7 of the thread are outputted to the bus IF unit 4-10 with an access request 10-5.

A last acceptance thread ID valid bit 10-9 and a last acceptance thread ID (10-10) are used for control similar to the control for which the last acceptance PU information valid bit (4-13) and the last acceptance PU ID (4-14) are used in the first embodiment. However, instead of an ID of the processor unit which has issued the accepted bus access request, a thread number corresponding to the accepted bus access request is set to the last acceptance thread ID (10-10). In other words, what is set is the thread ID (10-6) of the thread assigned to the cycles in which the access request 10-5 is asserted.

In the thread 0 access attribute setting register 10-2, in the thread 1 access attribute setting register 10-3, and in the thread 2 access attribute setting register 10-4, attributes can be set with any given meaning for each system. In the present embodiment, attributes indicating whether or not to perform issuance inhibition control are set. Here, the description is provided using a case example where “valid” is set in the thread 0 access attribute setting register 10-2, “invalid” is set in the thread 1 access attribute setting register 10-3, and “valid” is set in the thread 2 access attribute setting register 10-4. In this example, the control is performed so that the bus access performance is equally distributed among the thread 0 and the thread 2.

In the case where the thread 0 is to make bus access, “ID0” is outputted as the thread ID (10-6) and “valid” is outputted as the access attribute 10-7 at the same timing as when the access request 10-5 is asserted. When the arbiter 404 accepts this request, the last acceptance thread ID valid bit 10-9 is set, and “ID0” is set as the last acceptance thread ID (10-10). Further, since the access request 10-5 is asserted, and access to the shared memory 4-24 is executed.

The last acceptance thread ID valid bit 10-9 is set until the access to the shared memory 4-24 is completed, unless there is another bus access request. In the case where a bus access request is further issued by the thread 0 in this state, the arbiter 404 does not accept the request, since the access attribute 10-7 is “valid” and the thread ID (10-6) matches the ID of the last acceptance thread ID (10-10). Therefore, an access acceptance 10-8 is not asserted. This request is accepted when the last acceptance thread ID valid bit 10-9 is cleared, that is, when the bus access of the thread set as the last acceptance thread ID (10-10) is completed, or, when another thread issues a bus access request.

Since the access request 10-5 is not accepted, when there is a bus access request from another thread in the next cycle, the multithread processor 10-1 issues an access request thereof. Thus, the access request 10-5 is temporarily negated. In the case where there is no bus access request from another thread, the access request 10-5 corresponding to the thread 0 continues to be asserted.

Next, the following shall describe the operations of the arbiter 404 in the case where bus access requests are consecutively issued by the thread 1 for which “invalid” is set in the thread 1 access attribute setting register 10-3, in the status where there is no bus access request from another thread. In the case where the thread 1 is to make bus access, the access request 10-5 is asserted, and at the same time, “invalid” is outputted as the access attribute 10-7. When this request is accepted, the last acceptance thread ID valid bit (10-9) is set, and “ID1” is set as the last acceptance thread ID (10-10). When the thread 1 is to further make new bus access in this state, the access request 10-5 is asserted again, and at the same time, “invalid” is outputted as the access attribute 10-7. In this situation, this request is accepted although the last acceptance thread ID valid bit 10-9 is set and the last acceptance thread ID (10-10) matches the thread ID (10-6) of the thread which has asserted the previous access request 10-5. This request is accepted because “invalid” is outputted as the access attribute 10-7 and it is judged not to be the subject to inhibition control even when the last acceptance thread ID valid bit 10-9 is set and the last acceptance thread ID (10-10) matches the thread ID (10-6). When this request is accepted, the last acceptance thread ID valid bit 10-9 is set again and the last acceptance thread ID (10-10) is updated, but this has no impact on the subsequent operations.

The last acceptance thread ID valid bit 10-9 and the last acceptance thread ID (10-10) are set and cleared in the similar manner to that in the first embodiment. More specifically, the last acceptance thread ID valid bit 10-9 is set and reset at the following timings. In the case where the last acceptance thread ID valid bit 10-9 has not been set yet, it is set when the access request 10-7 is accepted. In the case where the last acceptance thread ID valid bit 10-9 has already been set, it is cleared when a new access request 10-7 is accepted or when it is judged that the transfer corresponding to the thread ID held as the last acceptance thread ID (10-10) is completed, based on a thread 0 transfer-in-progress signal 10-11, a thread 0 transfer-completed signal 10-12, a thread 1 transfer-in-progress signal 10-13, a thread 1 transfer-completed signal 10-14, a thread 2 transfer-in-progress signal 10-15, and a thread 2 transfer-completed signal 10-16.

Note that the access attribute in the fifth embodiment indicates “valid” or “invalid”, however, there is also an approach of setting groups to be subject to the restriction, and setting the access attribute to indicate which group each thread belongs to.

For example, in the case where a particular program (referred to as program A) is allocated to the thread 0 and the thread 1 sequentially for execution, and another program (referred to as program B) is executed by the thread 2, and where it is desired to equally distribute the bus access performance among the program A and the program B, it is effective to perform the inhibition control of the consecutive access in the following manner: The access from the thread 0 and the thread 1 is controlled collectively, and the access from the thread 2 is controlled as access from the thread 2 alone. In such a case, the program A is defined as a restriction group 0 and the program B is defined as a restriction group 1. Further, “restriction group 0” is set in the thread 0 access attribute setting register 10-2 and in the thread 1 access attribute setting register 10-3 in advance, and “restriction group 1” is set in the thread 2 access attribute setting register 10-4 in advance. In the fifth embodiment, the restriction control of the consecutive request acceptance is performed on the same thread when the access attribute indicates “valid”. However, the restriction control can be also performed on different threads, given that the threads have the same access attribute, that is, the threads belongs to the same restriction group.

Note that in the case where the bus IF unit has queues for requests, a similar variation to that of the first embodiment is possible with the fifth embodiment. In addition, it is needless to state that the structure of the fifth embodiment can be combined with any of the structures described in the second embodiment through the fourth embodiment. Furthermore, the multithread processor may be a multiprocessor.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

As described above, with the present invention, it is possible to equally distribute, among processors in a system having plural processors, the access performance for accessing a shared memory, and also, it is possible to equally distribute the access performance among plural threads in a multithread processor. Thus, the present invention can be applied to processor systems.

What is claimed is:

1. A processor system comprising:
a bus connected to a shared memory;
master units each of which is operable to issue an access request for accessing the shared memory; and
a bus interface unit operable to access said bus by a split-transaction scheme and to execute a request phase and a transfer phase separately, the request phase being a phase for accepting the access request issued by each of said master units, and the transfer phase being a phase for executing data transfer between the shared memory and each of said master units via said bus in response to the accepted access request,
wherein said bus interface unit is operable, in the case where one of said master units consecutively issues plural access requests without an interval of a predetermined time period between each of the access requests, to restrict the number of consecutive executions of transfer phases to be not more than N, the transfer phases respectively corresponding to the plural access requests, and
the predetermined time period is equivalent to a part of or an entire time period from when an immediately previously issued access request is accepted, to when the transfer phase corresponding to the immediately previously issued access request is completed.

2. The processor system according to claim 1,
wherein N is 1.

3. The processor system according to claim 1,
wherein said bus interface unit includes:
an acceptance controlling unit operable to control the acceptance of the access request;
a transfer controlling unit operable to control the data transfer;
an identification information holding unit operable to hold identification information of at least one of said master units, the identification information of the at least one of said master units corresponding to the access request which has been accepted and for which the transfer phase has not been completed; and
a flag holding unit operable to hold flag information which is valid during the predetermined time period, and
when a new access request is issued, said acceptance controlling unit is operable to:
accept the new access request in the case where the flag information is invalid;
judge whether or not identification information of one of said master units which has issued the new access request and the identification information held by said identification information holding unit match each other, in the case where the flag information is valid;
accept the new access request in the case where it is judged that the identification information of the one of said master units which has issued the new request and the identification information held by said identification information holding unit do not match each other; and
restrict the number of consecutive executions of the transfer phases to be not more than N, in the case where it is judged that the identification information of the one of said master units which has issued the new request and the identification information held by said identification information holding unit match each other, the transfer phases corresponding to the one of said master units which has issued the new access request.

4. The processor system according to claim 3,
wherein the predetermined time period is a time period from when the access request is accepted, to when the transfer phase corresponding to the access request is completed,
said acceptance controlling unit is operable, every time the access request is accepted, to validate the flag information held by said flag holding unit and set the identification information corresponding to the access request in said identification information holding unit, and
said transfer controlling unit is operable to invalidate the flag information held by said flag holding unit when the transfer phase corresponding to the identification information held by said identification information holding unit is completed.

5. The processor system according to claim 3,
wherein the predetermined time period is a time period from when the access request is accepted, to when a predetermined number of cycles elapse, and
said processor system further comprises
a cycle counter which counts the predetermined number of cycles,
wherein said acceptance controlling unit is operable, every time the access request is accepted, to validate the flag information held by said flag holding unit, set the identification information corresponding to the access request in said identification information holding unit, and cause said cycle counter to start counting the predetermined number of cycles, and
said flag holding unit is operable to invalidate the flag information when said cycle counter has counted the predetermined number of cycles.

6. The processor system according to claim 5, further comprising
a cycle register operable to hold the predetermined number of cycles, the predetermined number of cycles being settable,
wherein said cycle counter counts the predetermined number of cycles held by said cycle register.

7. The processor system according to claim 1,
wherein said bus interface unit includes:
an acceptance controlling unit operable to control the acceptance of the access request;
a transfer controlling unit operable to control the data transfer;
an identification information holding unit operable to hold identification information of at least one of said master units, the identification information of the at least one of said master units corresponding to the access request which has been accepted and for which the transfer phase has not been completed;
a flag holding unit operable to hold flag information which is valid during the predetermined time period; and
a consecutive number counter which counts N, and
when a new access request is issued, said acceptance controlling unit is operable to:
accept the new access request in the case where the flag information is invalid;
judge whether or not identification information of one of said master units which has issued the new access request and the identification information held by said identification information holding unit match each other, in the case where the flag information is valid;
accept the new access request in the case where it is judged that the identification information of the one of said master units which has issued the new request and the identification information held by said identification information holding unit do not match each other;
judge whether or not said consecutive number counter has counted N, in the case where it is judged that the identification information of the one of said master units which has issued the new request and the identification information held by said identification information holding unit match each other;
accept the new access request in the case where it is judged that said consecutive number counter has not counted N; and
delay the acceptance of the new access request until the flag information becomes invalid and initialize said consecutive number counter, in the case where it is judged that said consecutive number counter has counted N.

8. The processor system according to claim 7, further comprising:
a consecutive number register which can be set by one of said master units and is operable to hold N,
wherein said consecutive number counter counts N held by said consecutive number register.

9. The processor system according to claim 7,
wherein the predetermined time period is a time period from when the access request is accepted, to when the transfer phase corresponding to the access request is completed,
said acceptance controlling unit is operable, every time the access request is accepted, to validate the flag information held by said flag holding unit and set the identification information corresponding to the access request in said identification information holding unit, and
said transfer controlling unit is operable to invalidate the flag information held by said flag holding unit when the transfer phase corresponding to the identification information held by said identification information holding unit is completed.

10. The processor system according to claim 1,
wherein said bus interface unit includes:
an acceptance controlling unit operable to control the acceptance of the access request;
a transfer controlling unit operable to control the data transfer;
a first identification information holding unit operable to hold, as first identification information, identification information of at least one of said master units, the identification information of the at least one of said master units corresponding to the access request which has been accepted and for which the transfer phase has not been completed;
a flag holding unit operable to hold flag information which is valid during the predetermined time period; and
a second identification information holding unit operable to hold, as second identification information, identification information of one of said master units, which is to be restricted from accessing the shared memory, and
when a new access request is issued, said acceptance controlling unit is operable to:
accept the new access request in the case where the flag information is invalid;
judge whether or not identification information of one of said master units which has issued the new access request matches the first identification information and the second identification information, in the case where the flag information is valid;
accept the new access request in the case where it is judged that the identification information of the one of said master units which has issued the new request does not match at least one of the first identification information and the second identification information; and
delay the acceptance of the new access request until the flag information becomes invalid, in the case where it is judged that the identification information of the one of said master units which has issued the new request matches both the first identification information and the second identification information.

11. The processor system according to claim 10, further comprising:
a counting unit operable to count how many times each of said master units has accessed the shared memory in every fixed time period; and
a setting unit operable to set, in said second identification information holding unit, identification information of one of said master units which has accessed the shared memory a greatest number of times, as the second identification information.

12. The processor system according to claim 1,
wherein said bus interface unit includes:
an acceptance controlling unit operable to control the acceptance of the access request;
a transfer controlling unit operable to control the data transfer;
an identification information holding unit operable to hold identification information of at least one of said master units, the identification information of the at least one of said master units corresponding to the access request which has been accepted and for which the transfer phase has not been completed; and
a flag holding unit operable to hold flag information which is valid during the predetermined time period; and
said transfer controlling unit is operable to:
execute the transfer phase corresponding to the access request which has been accepted and for which the transfer phase has not started, in the case where the flag information is invalid;
judge whether or not identification information of one of said master units that has issued the access request which has been accepted and for which the transfer phase has not started, and the identification information held by said identification information holding unit match each other, in the case where the flag information is valid;
start the transfer phase corresponding to the access request which has been accepted and for which the transfer phase has not started, in the case where it is judged that the identification information of the one of said master units that has issued the access request which has been accepted and for which the transfer phase has not started, and the identification information held by said identification information holding unit do not match each other; and
delay the start of the transfer phase until the flag information becomes invalid, in the case where it is judged that the identification information of the one of said master units that has issued the access request which has been accepted and for which the transfer phase has not started, and the identification information held by said identification information holding unit match each other.

13. The processor system according to claim 12,
wherein the predetermined time period is a time period from when the access request is accepted, to when the transfer phase corresponding to the access request is completed,
said acceptance controlling unit is operable, every time the access request is accepted, to validate the flag information held by said flag holding unit and set the identification information corresponding to the access request in said identification information holding unit, and
said transfer controlling unit is operable to invalidate the flag information held by said flag holding unit when the transfer phase corresponding to the identification information held by said identification information holding unit is completed.

14. The processor system according to claim 1,
wherein said master units are processor units included in a symmetric multiprocessor.

15. The processor system according to claim 1,
wherein said master units are virtual processors provided in processor units included in a multiprocessor.

16. The processor system according to claim 1,
wherein said master units are virtual processors corresponding to threads included in a multithread processor.

17. The processor system according to claim 1,
wherein said master units and said bus interface unit are included in a single semiconductor chip.

18. A processor system comprising:
a bus connected to a shared memory;
a multithread processor which includes virtual processors and executes said virtual processors, each of said virtual processors including at least one thread and issuing an access request for accessing the shared memory; and
a bus interface unit operable to access said bus by a split transaction scheme and to execute a request phase and a transfer phase separately, the request phase being a phase for accepting the access request issued by each of said virtual processors, and the transfer phase being a phase for executing data transfer between the shared memory and each of said virtual processors via said bus in response to the accepted access request,
wherein said bus interface unit is operable, in the case where one of said virtual processors consecutively issues plural access requests without an interval of a predetermined time period between each of the access requests, to restrict the number of consecutive executions of transfer phases to be not more than N, the transfer phases respectively corresponding to the plural access requests, and
the predetermined time period is equivalent to a part of or an entire time period from when an immediately previously issued access request is accepted, to when the transfer phase corresponding to the immediately previously issued access request is completed.

19. The processor system according to claim 18,
wherein said multithread processor issues identification information and an access attribute of a thread, in addition to the access request,
the access attribute indicates whether or not restriction on the consecutive executions of the transfer phases should be valid, and
said bus interface unit is operable to restrict the number of consecutive executions of the transfer phases to be not more than N, in the case where the access attribute corresponding to the access request indicates valid.

20. The processor system according to claim 18,
wherein said multithread processor issues identification information and an access attribute of a thread, in addition to the access request,
the access attribute is a group number indicating a group including at least one thread, and
said bus interface unit is operable to restrict, for every group number, the number of consecutive executions of the transfer phases to be not more than N, the transfer phases corresponding to the access requests of one group.

21. A bus controlling method for use in a processor system which includes:
a bus connected to a shared memory;
master units each of which is operable to issue an access request for accessing the shared memory;
a bus interface unit operable to access said bus by a split transaction scheme and to execute a request phase and a transfer phase separately, the request phase being a phase for accepting the access request issued by each of the master units, and the transfer phase being a phase for executing data transfer between the shared memory and each of the master units via the bus in response to the accepted access request;
an identification information holding unit operable to hold identification information of one of the master units, the identification information of the one of the master units corresponding to an access request which has been last accepted and for which the transfer phase has not been completed; and
a flag holding unit operable to hold flag information which is valid during a time period equivalent to a part of or an entire time period which ends when the transfer phase for the access request which corresponds to the identification information held by the identification information holding unit is completed,
said bus controlling method comprising:
storing, in the identification information holding unit and in the flag holding unit, the identification information of the one of the master units corresponding to the access request which has been last accepted and for which the transfer phase has not been completed, and the flag information which is valid during a time period equivalent to a part of or an entire time period which ends when the transfer phase for the access request which corresponds to the identification information is completed, respectively;
judging, when a new access request is issued, whether or not identification information of one of the master units which has issued the new access request and the identification information held by the identification information holding unit match each other, in the case where the flag information is valid;
accepting the new access request in the case where it is judged in said judging that the identification information of the one of the master units which has issued the new access request and the identification information held by the identification information holding unit do not match each other, and accepting the new access request in the case where the flag information is invalid; and
restricting the number of consecutive executions of transfer phases to be not more than N, in the case where it is judged in said judging that the identification information of the one of said master units which has issued the new request and the identification information held by said identification information holding unit match each other, the transfer phases corresponding to the one of said master units which has issued the new access request.

22. A semiconductor device comprising a processor system including:
a bus connected to a shared memory;
master units each of which is operable to issue an access request for accessing the shared memory; and
a bus interface unit operable to access said bus by a split transaction scheme and to execute a request phase and a transfer phase separately, the request phase being a phase for accepting the access request issued by each of said master units, and the transfer phase being a phase for executing data transfer between the shared memory and each of said master units via said bus in response to the accepted access request,
wherein said bus interface unit is operable, in the case where one of said master units consecutively issues plural access requests without an interval of a predetermined time period between each of the access requests, to restrict the number of consecutive executions of transfer phases to be not more than N, the transfer phases respectively corresponding to the plural access requests, and
the predetermined time period is equivalent to a part of or an entire time period from when an immediately previously issued access request is accepted, to when the transfer phase corresponding to the immediately previously issued access request is completed.
